(19) United States
(12) Patent Application Publication
(10) Pub. No.: US 2024/0227654 A1
(43) Pub. Date: Jul. 11, 2024

(54) Variable footprint handling apparatus for handling containers

(71) Applicant: ACHA S.R.L., Bologna (IT)

(72) Inventor: Giancarlo BONFIGLIOLI, Castello d’Argile (BO) (IT)

(21) Appl. No.: 18/557,624

(22) PCT Filed: Apr. 15, 2022
(86) PCT No.: PCT/IB2022/053563

§ 371 Date: Oct. 27, 2023

(30) Foreign Application Priority Data
Apr. 30, 2021 (IT) 102021000011075
Apr. 30, 2021 (IT) 102021000011087
Sep. 30, 2021 (IT) 102021000025097

(51) Int. Cl. B60P 1/54; B60P 3/28; B66C 23/36

(52) U.S. Cl. CPC B60P 1/5471; B60P 3/28; B66C 23/36

(57) ABSTRACT

A variable footprint handling apparatus (501, 501′, 501″) for handling containers (105) is described comprising: a first column (555) adapted to be associated with the fifth wheel (530) of a tractor (510), a second column (575) to which a first idle ground support wheel (580) is idly associated, a third column (600) to which a second idle ground support wheel (605) is idly associated, a lifting arrangement (640, 645, 650, 655, 660, 665, 670, 675, 680, 685) for lifting the container (105), and a connection arrangement (620, 630, 635) that connects the second column (575) and the third column (600) to the first column (555) and is configured to move at least one of the three columns with respect to another of the three columns between a first position, and a second position, in which a footprint in plan of the apparatus in said second position is smaller than a footprint in plan of the apparatus in said first position.

### TECHNICAL FIELD

The present invention relates to a container handling apparatus (ISO) of the variable footprint type, i.e., capable of being arranged in a working configuration in which it allows containers to be lifted and lowered, for example to and from the carriage of an articulated truck, and a storage/transport configuration in which containers cannot be lifted or lowered. In particular, the footprint of the apparatus in the storage/transport configuration is smaller than the footprint in the working configuration, so that the apparatus can be transported on the carriage of a standard articulated truck and on normal roads open to the public.

### PRIOR ART

Apparatuses are known for handling containers able to vary their footprint, intended as the set of the maximum height, width and length of the apparatus, in order to switch from a working configuration, in which they can lift/lower and transport by land a container, generally a single container or at most two containers, to a storage or transport configuration, in which the footprint of the apparatus is reduced compared to the working configuration, so that it can for example be transported on the truck of a standard articulated truck circulating on urban roads.

Such apparatuses generally comprise a variable footprint frame, for example comprising telescopic vertical side members and/or uprights, which variable footprint frame rests on the ground by means of at least 3, preferably four wheels, at least one, preferably two, of which are drive wheels in order to be able to move the frame and therewith the container which by means of an apparatus lifting arrangement has been associated with the container.

The apparatus is therefore provided with a motor, to provide the necessary force to the drive wheels to move the apparatus, and a cockpit to allow an operator to drive the apparatus. The motor may be a hydraulic motor that is driven by the fluid placed under pressure by a motor pump connected to the variable footprint frame.

As can be guessed, the motor and the cockpit have considerable footprints which do not match with the need to minimize the footprint of the apparatus in the storage/transport configuration. As can also be guessed that such components complicate and lengthen design/construction times and constitute a significant weight burden.

An object of the present invention is to solve the aforesaid problems of the apparatuses of the prior art.

Such object is achieved by the features of the invention indicated in the independent claim. The dependent claims outline preferred and/or particularly advantageous aspects of the invention.

### DISCLOSURE OF THE INVENTION

The technical features of the proposed invention, in all its variants and embodiments, make available a variable footprint container handling apparatus which has the advantage that in a closed configuration said apparatus can be positioned on the carriage of a standard articulated truck or truck without exceeding the maximum footprint values for transport on roads open to the public, i.e. 4 metres maximum height and 2.55 metres maximum width, and therefore can be easily transported along roads open to the public. It should be noted that carriage of a standard articulated truck or truck means a carriage provided with a flat upper surface adapted to support the load to be transported with the carriage and whose height from the ground is less than 1.6 metres.

In particular, the invention makes available a variable footprint handling apparatus for handling containers comprising:
a first column adapted to be associated to the fifth wheel of a tractor,
a second column to which a first idle ground support wheel is idly associated,
a third column to which a second idle ground support wheel is idly associated,
a lifting arrangement for lifting the container,
a connection arrangement that connects the second column and the third column to the first column and is configured to move at least one of the three columns with respect to another of the three columns between a first position, and a second position, in which a footprint in plan of the apparatus in said second position is smaller than a footprint in plan of the apparatus in said first position.

Thanks to this solution, an apparatus for handling containers, of the type with variable footprint, is made available which is more compact, light, easily transportable and economical, with the same performance, compared to prior art devices. In particular, such advantages are allowed by the fact that the apparatus does not need drive wheels to handle containers, as it can exploit the drive wheels of the tractor provided with fifth wheel (or any other equivalent connection element) to which the first column is adapted to be connected, for example associated in idle mode. Accordingly, since it does not need any drive wheels, it does not need to be provided with motors, generally hydraulic/oleodynamic, used by apparatuses of prior art to rotate the ground support wheels, nor with means for controlling and orienting the drive wheels and for driving the apparatus, since such means are also already included in the tractor. As also set forth below, the apparatus may comprise a pump, driven by an electric motor or endothermic motor, for generating pressurized fluid which allows the connection arrangement to be activated, which, since it does not also have to provide sufficient force to also activate the drive wheels, may be smaller than the apparatuses of prior art, and therefore less bulky. Moreover, it is not excluded that the apparatus may also not comprise an on-board pump to activate the connection arrangement and may be connected to a pump external to the apparatus, thus making it even lighter and more compact. The apparatus is also transportable on the carriage of a standard articulated truck on roads open to the public, as once it is brought into transport configuration does not protrude from the carriage of the articulated truck.

According to one aspect of the invention the connection arrangement can be configured to move at least one between the second column and the third column between a first position, in which the distance of the third column from the second column is maximum, and a second position in which said distance is minimum.

According to one aspect of the invention, designed to improve the compactness of the system when in the transport configuration while maintaining high functionality in the operating configuration, the connection arrangement may comprise:
a first crosspiece provided with a first end connected to the first column and a second end connected to the third column,
a second crosspiece provided with a first end rigidly fixed to the second column and a second end hinged to one between the first column and the first crosspiece with respect to a vertical axis of rotation,
an actuator configured to move the second column in rotation with respect to said vertical axis of rotation.

Still another aspect of the invention provides that the actuator may be a linear actuator provided with a first end hinged to one between the first column, the first crosspiece and the third column and an opposite second end hinged to one between the second column and the second crosspiece.

Still another aspect of the invention provides that the third column and the second column may be of a telescopic type.

In this way it is possible, for the same footprint in the operating configuration, to reduce the footprint in the transport configuration.

Another aspect of the invention according to which the first column and the first crosspiece can be of the telescopic type may contribute to improve this advantage.

In addition, this feature allows the column to be lifted to a point where the first crosspiece and the second crosspiece are above the tractor, thus allowing the apparatus to be brought in front of the tractor for better manoeuvrability, and at the same time allowing the apparatus to be loaded onto the carriage.

According to one aspect of the invention, the lifting arrangement may comprise:
a first arm connected to the second column and developing transversely thereto along a longitudinal direction,
a second arm connected to the third column and developing transversely thereto along a longitudinal direction,
a first container gripping body integral with a first rope at least partially wrapped around a first wheel hinged near a first end of the first arm distal from the second column and operated by means of a first actuator,
a second container gripping body integral with a second rope at least partially wrapped around a second wheel hinged near a second end of the first arm distal from the second column and opposite to the first, and operated by means of a second actuator,
a third container gripping body integral with a third rope at least partially wrapped around a third wheel hinged near a first end of the second arm distal from the third column and operated by means of a third actuator,
a fourth container gripping body integral with a fourth rope at least partially wrapped around a fourth wheel hinged near a second end of the second arm distal from the third column and opposite the first, and operated by means of a fourth actuator, and wherein at least one between the first arm and the second arm is hinged to the respective column according to a vertical hinge axis.

In this way it is possible to reduce the footprint of the apparatus, which otherwise, if all the two arms were rigidly fixed, that is rigidly fixed without any residual degree of freedom with respect to the column, would touch each other, in the passage from the first position to the second position, well before the proposed solution, which allows at least one of the arms to adapt to the other, keeping them, for example, parallel instead of incident, and therefore allows to bring the second column and the third column closer one another.

According to another aspect of the invention, the apparatus may comprise a pump driven by a motor and operatively connected to the connection arrangement for moving the first column between the first and second position and wherein said pump and said motor are connected to one of said three columns or said connection arrangement.

According to an alternative embodiment of the invention, the second end of the first crosspiece may be hinged to the third column with respect to a first axis of rotation and wherein the first end of the second crosspiece may be hinged to the second column with respect to a second axis of rotation.

In this way it is possible to rotate the first and the second column in relation to the respective crosspieces of the connection arrangement, the apparatus thus makes it possible to keep the ground support wheels parallel to each other even when loads larger or smaller than an ISO container are handled. In the absence of such characteristics, outside of an optimal design distance between the third and the second column, in the other positions, since the wheels are hinged to the columns only with respect to horizontal axes of rotation, the wheels would roll on incident trajectories, and therefore would be forced to creep in case of movement of the apparatus on a straight axis.

According to another aspect of the invention, the first idle wheel and the second idle wheel of the apparatus may be rotatably associated with the male section of the second column and of the third column, and may be completely in an external position and adjacent thereto.

According to a further aspect of the invention, the female section of each column may be movable between a first position, in which a lower end thereof is located at a vertical height greater than a maximum vertical height of the wheel, and a second position, in which the lower end of the female section is located at a vertical height lower than the maximum vertical height of the wheel.

According to this characteristic, it is possible to realise a crane that in the condition in which the telescopic columns are folded presents a lower height from the ground than other architectures of connection of the wheels to the respective columns.

According to another aspect of the invention, each wheel may be rotatably associated with the male section of the respective column with respect to a horizontal axis of rotation and at a lower end portion of said male section.

According to a similar aspect of the invention, the wheel may be associated with the male section of the respective column in such a way that a top portion of the wheel is located at a vertical height equal to or higher than a vertical height of a lower end of the male section.

This characteristic contributes to reducing the space between the lower end of the male section and the ground on which the wheel rests, thus making the apparatus more compact than a solution in which the wheel is completely at a height lower than the column, such as in the case where the wheel is below the respective column.

Similarly, the wheel may be associated with the male section in such a way that the axis of rotation is located at a vertical height equal to or greater than a vertical height of a lower end of the male section.

This is particularly advantageous when configuring the apparatus with large wheels, as this reduces the vertical footprint of the apparatus.

The invention also makes available a system for handling containers comprising a tractor, provided with a fifth wheel, and an apparatus according to claim 1, wherein the first column is removably connected to the fifth wheel of the tractor.

### BRIEF DESCRIPTION OF THE DRAWINGS

Further features and advantages of the invention will be more apparent after reading the following description provided by way of non-limiting example, with the aid of the accompanying drawings.

FIG. 1 is a schematic plan view of a container handling system according to the invention, comprising a container handling apparatus according to the invention, illustrated in a step of handling a container by land.

FIG. 2 is a schematic side view of the system of FIG. 1.

FIG. 3 is a schematic side view of the container handling system of the preceding figures, illustrated in a step of picking up or unloading a container with respect to the carriage of an articulated truck.

FIG. 4 is a schematic side view of the container handling apparatus of the preceding figures, illustrated in a transport configuration while being transported on the carriage of an articulated truck.

FIG. 5 is a schematic plan view of what is illustrated in FIG. 4.

FIG. 6 is a schematic plan view illustrating a step in the passage of the apparatus from an operating configuration to a transport configuration.

FIG. 7 is a schematic plan view of a tractor of the system of the preceding figures.

FIG. 8 is a schematic plan view of an alternative embodiment of the apparatus of the preceding figures in which the second crosspiece is telescopic.

FIG. 9 is a schematic plan view of the system of the preceding figures in which the tractor is placed laterally to the apparatus and container.

FIG. 10 is a schematic plan view of a container handling system according to the invention, comprising a container handling apparatus according to the invention, illustrated in a step of handling a container by land.

FIG. 11 is a schematic side view of the system of FIG. 1.

FIG. 12 is a schematic side view of the container handling system of the preceding figures, illustrated in a step of picking up or unloading a container with respect to the carriage of an articulated truck.

FIG. 13 is a schematic side view of the container handling apparatus of the preceding figures, illustrated in a transport configuration while being transported on the carriage of an articulated truck.

FIG. 14 is a schematic side view of what is illustrated in FIG. 4.

FIG. 15 is a schematic plan view showing the apparatus in a transport configuration.

FIG. 16 is a schematic plan view of a tractor of the system of the preceding figures.

FIG. 17 is a schematic plan view of an alternative embodiment of the system according to the invention, illustrated in a step of handling a container by land.

FIG. 18 is a schematic plan view of an apparatus of the system of FIG. 17, illustrated in a transport configuration.

FIG. 19 is a schematic plan view of an alternative embodiment of the apparatus according to the invention.

FIG. 20 is a schematic sectional view of a telescopic column or crosspiece, illustrating a characteristic shape of one between the first column, the second column, the third column, the first crosspiece or the second crosspiece of embodiments of the crane according to the invention.

FIG. 21 is a schematic plan view of a male section of the telescopic column or crosspiece of FIG. 20.

FIG. 22 is a schematic plan view of a female section of the telescopic column or crosspiece of FIG. 20.

FIG. 23 is a schematic sectional view of a telescopic column or crosspiece, illustrating an alternative characteristic shape of one between the first column, the second column, the third column, the first crosspiece or the second crosspiece of the embodiments of the crane according to the invention.

FIG. 24 is a schematic plan view of a male section of the telescopic column or crosspiece of FIG. 23.

FIG. 25 is a schematic plan view of a female section of the telescopic column or crosspiece of FIG. 23.

FIG. 26 is a schematic side view of an embodiment of the system of FIG. 11, having the idle wheels associated externally to the column and wherein the female section of the column is in a first position thereof.

FIG. 27 is a schematic side view of the system of FIG. 26, shown in a configuration thereof wherein the female section of the column is in a second position thereof.

FIG. 28 is a schematic sectional view of the system of FIG. 26 according to the section plane A-A.

FIG. 29 is a schematic side view of an embodiment of the apparatus alternative to those shown in FIGS. 1-28.

### BEST MODE OF THE INVENTION

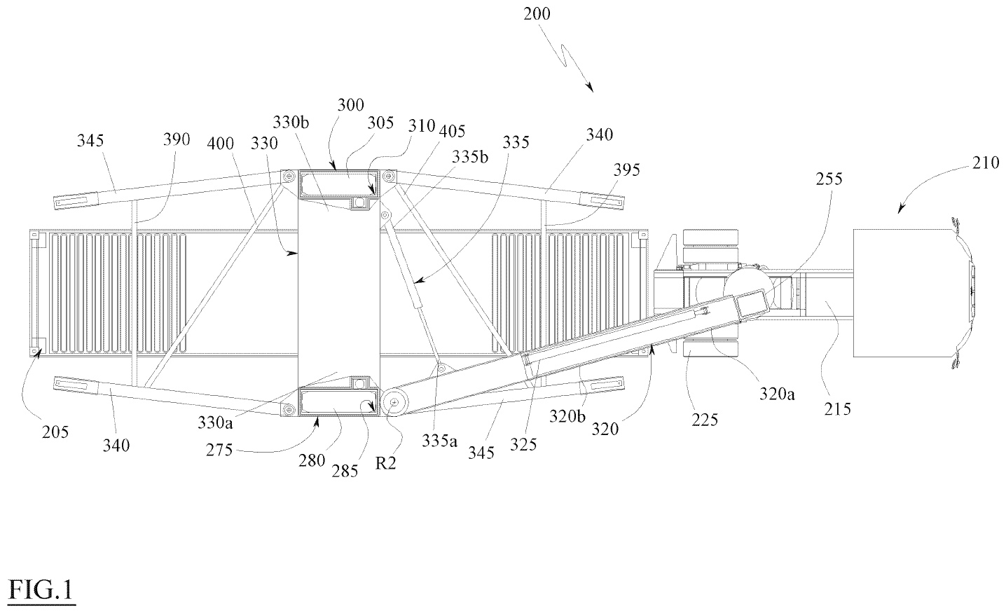

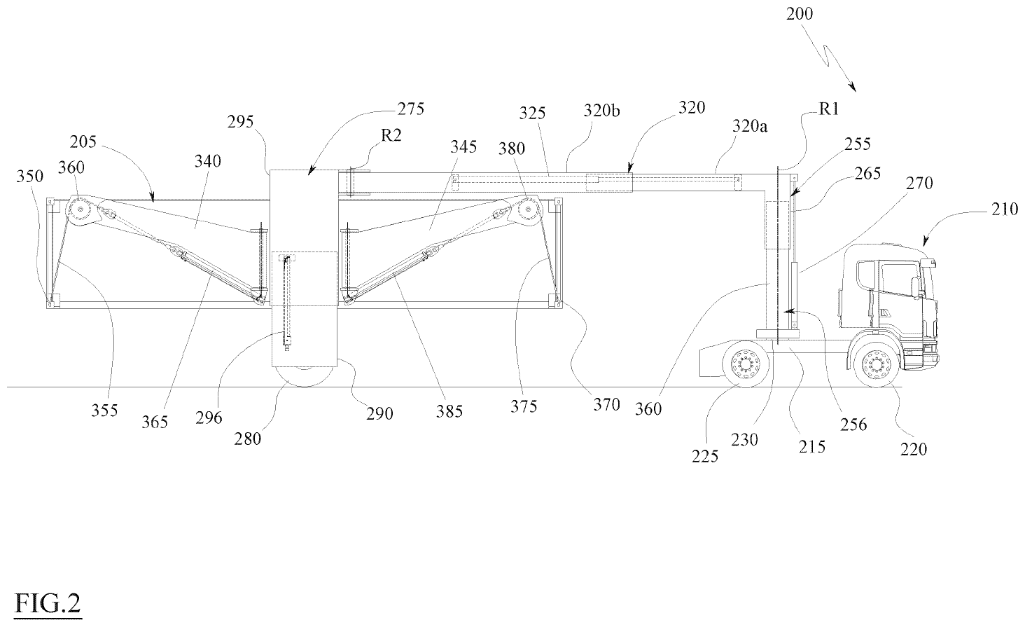

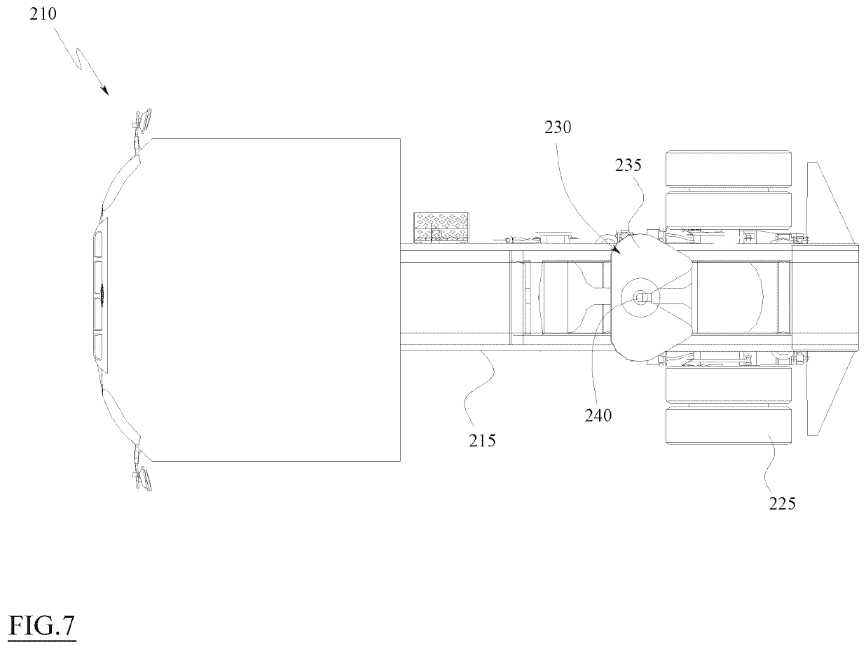

With particular reference to FIGS. 1-9, a system for handling containers 205 (ISO containers), in particular of the type capable of moving autonomously along roads and motorways open to the public, has been globally indicated with 200. In the illustrated embodiment, there is a system 200 capable of handling a single container, however, with appropriate dimensional modifications of the system well within the reach of the person skilled in the art, the inventive concept underlying the system can be adapted to transport two containers stacked vertically one on top of the other.

The container 205 that can be handled by the system is preferably an ISO container (provided with coupling elements, for example in the form of pins and/or slots), adapted to be grasped by the system 200, for example by means of hooks.

The system 200 comprises a tractor 210, i.e., a self-propelled vehicle suitable for land transportation, which comprises a frame 215 to which at least one pair of drive and steering wheels 220 or one pair of drive wheels and one pair of steering wheels (and possibly, generally, also at least one pair of idle wheels 225) are associated.

The tractor illustrated is that of an articulated vehicle, i.e. a self-propelled vehicle adapted to transport carriages resting on the ground by means of idle wheels, however it is not excluded that the tractor may be another self-propelled vehicle, such as a forklift.

It is specified that a carriage is defined as a frame having a flat upper surface for supporting goods, for example a container, and to which a plurality of ground support wheels, all of which are idle wheels, is associated. In practice, the carriage needs a tractor to be moved.

The tractor 210 comprises a motor (not illustrated), for generating the force necessary for the drive wheels to move the tractor, and a transmission (in the case where the motor is endothermic) for carrying the energy of the motor to the drive wheels.

The tractor 210 further comprises a steering system (not illustrated), for controlling the steering wheels or the steering and drive wheels, and a cockpit adapted to accommodate a tractor operator and controls for operating said tractor systems.

The tractor 210 comprises a fifth wheel 230 (internationally known) associated with the frame of the tractor and which is adapted to allow the removable connection of a carriage to be towed and which inferiorly supports a portion of said carriage.

Specifically, the fifth wheel 230 comprises a plate, provided with a substantially flat upper surface 235 (which is generally lubricated to reduce friction with the portion of the carriage placed on top of it), in which plate a recess 240 adapted to allow the insertion of a pin of the carriage, is made.

The fifth wheel then comprises a locking mechanism configured to selectively retain and release a pin (of the carriage) inserted inside the recess.

The cockpit is positioned in a front portion of the tractor, while the fifth wheel 230 is positioned in a rear portion of the tractor.

The system 200 further comprises a variable footprint handling apparatus 201 (hereinafter abbreviated as apparatus 201) for handling containers 205. In particular, the handling performed by the apparatus involves lifting, lowering and keeping the container suspended from the ground. By connecting the apparatus to the tractor 210, as will become clearer in the following, it then becomes possible to handle the container by moving it horizontally in space while the apparatus keeps the container suspended in the air.

The apparatus 201 is a variable footprint apparatus as it is able to vary its footprint between a working (or operating) configuration, in which it is possible to lift/lower and keep lifted a container (or a pair of containers) and a storage or transport configuration, in which the maximum overall footprint of the apparatus 201 is reduced compared to the working configuration.

It is specified that variable footprint means the possibility of varying at least one of its dimensions in the space between height, width and length. Width and length are perpendicular to each other and lie on a horizontal plane, whereas the height is measured vertically. Further, in this discussion, width will be used with reference to a measurement direction perpendicular to a straightforward direction of the tractor, in a condition where the apparatus 201 is connected to and aligned with the tractor (as is visible in the figures), and the length with reference to a measurement direction parallel to the straightforward direction of the tractor and perpendicular to the length.

The maximum overall footprint may be considered as the volume of the smallest parallelepiped that entirely contains the apparatus 201.

The apparatus 201 comprises a variable footprint frame, also definable as “with variable geometry”, adapted to be removably connected to the tractor 210, namely to the fifth wheel 230 of the tractor, to be moved by it.

In the illustrated embodiment, the frame is capable of varying its footprint in all three indicated directions (height, width and length). However, it is not excluded that in a non-illustrated, and less preferred embodiment, the frame is capable of varying its footprint only in the direction of its width or in the direction of width and length, but not in height. The variation in frame footprint allows the apparatus 201 to be operated between the operating configuration, in which it is capable of handling a container, i.e. lifting, lowering and keeping it suspended, and the transport or storage configuration, in which the apparatus 201 is adapted to be transported on the carriage of an articulated truck, i.e. a carriage connected to a tractor. In the transport configuration, the apparatus 201 is not configured to handle a container.

In the operating configuration the footprint of the frame (and of the apparatus 201) is maximum, while it is minimum in the transport or storage configuration.

Said variable footprint frame comprises a first column 255, which is vertical, i.e., it develops mainly longitudinally along a vertical axis, and is adapted to be removably connected to the tractor. In particular, the apparatus 201 is connected to the tractor only through the first column.

The first column 255 is adapted to be associated, i.e., is associated, idly with the fifth wheel 230 of the tractor so that the first column can rotate with respect to the tractor with respect to a vertical axis of rotation R1. Alternatively, the column may comprise a rigidly fixable lower portion, i.e., rigidly fixable without residual degrees of freedom, to the fifth wheel 230 and the remainder of the first column is rotatably associated with respect to said lower end with respect to the vertical axis of rotation R1.

For the connection to the fifth wheel, the first column comprises a coupling arrangement located at a lower end 256 of the first column.

Such a coupling arrangement may, for example, be the one known to a person skilled in the art for fixing a carriage to the fifth wheel of the tractor and may comprise a pin (not illustrated) adapted to be inserted into the recess 240 of the fifth wheel 230. Obviously, it cannot be excluded that, as an alternative to the fifth wheel, the tractor could comprise a system for the ad hoc connection of the first column. In such a case, the tractor could, for example, comprise a vertical pin on which a lower portion of the first column is fitted so as to realize a rotoidal pair with a vertical axis of rotation R1.

In the illustrated embodiment, the first column is of a telescopic type and capable of varying its longitudinal extension along a vertical direction.

Thus, the first column comprises a lower section 260 that comprises the lower portion of the first column and an upper section 265 that is movable with respect to the lower section along a vertical direction, such as by means of a linear actuator 270.

The variable footprint frame then comprises a second column 275 (vertical, i.e., developing longitudinally along a vertical axis) to which a first idle ground support wheel 280 is associated idly. In practice, the second column rests on the ground (only) by means of the first idle wheel which is connected to a lower end of the second column.

The first idle wheel 280 is rotatably associated with the second column 275 at least with respect to a horizontal axis of rotation. It is not excluded that the first idle wheel 280 may be rotatably associated idly with the second column 275 also with respect to a vertical axis of rotation, for example coaxial to a longitudinal axis of the column.

The first idle wheel 280 may be, at least partially, vertically aligned with the second column. Preferably, the second column entirely overlaps in plan the first idle wheel.

In the illustrated embodiment, in order to further reduce the footprints, the second column comprises a cavity 285 within which the first idle wheel 280 is at least partially contained. For example, the second column could also comprise a drive configured to selectively let the first idle wheel protrude from the cavity (so that at least one-third of the wheel protrudes) and to let it retract into the cavity (so that less than one-quarter of the wheel protrudes from the cavity), so as to allow a further reduction in footprints and at the same time allow obstacles to be overcome when the wheel is caused to protrude.

It is not excluded that the second column may comprise more than one ground support wheel idly hinged to the second column.

In the embodiment illustrated, the second column is of a telescopic type and capable of varying its longitudinal extension along a vertical direction. In particular, the second column may comprise a lower section 290 to which the first idle wheel 280 is directly associated in the manner described above, and an upper section 295 movable with respect to the lower section along a vertical axis. For example, the actuation of the second section may be through the linear actuator 296 shown in the figures.

The second column 275 is distinct and spaced by a non-zero amount from the first column.

The variable footprint frame also comprises a third column 300 (vertical, i.e., developing longitudinally along a vertical axis) to which a second idle ground support wheel 305 is associated idly. In practice, the third column rests on the ground (only) by means of the second idle wheel which is connected to a lower end of the third column.

The second idle wheel 305 is rotatably associated with the third column 300 at least with respect to a horizontal axis of rotation. It is not excluded that the second idle wheel 305 may be rotatably associated idly with the third column 300 also with respect to a vertical axis of rotation, for example coaxial to a longitudinal axis of the column.

The second idle wheel 305 may be, at least partially, vertically aligned with the third column. Preferably, the third column entirely overlaps in plan the second idle wheel.

In the illustrated embodiment, in order to further reduce the footprints, the third column comprises a cavity 310 within which the second idle wheel 305 is at least partially contained.

For example, the third column could also comprise a drive configured to let the second idle wheel protrude from the cavity (so that at least one-third of the wheel protrudes) and to let it retract into the cavity (so that less than one-quarter of the wheel protrudes from the cavity), so as to allow a further reduction in footprints and at the same time allow obstacles to be overcome when the wheel is caused to protrude.

It is not excluded that the third column may comprise more than one ground support wheel hinged idly to the third column.

In the embodiment illustrated, the third column is of a telescopic type and capable of varying its longitudinal extension along a vertical direction. In particular, the third column may comprise a lower section 300a to which the second idle wheel 305 is directly associated in the manner described above, and an upper section 300b movable with respect to the lower section along a vertical axis. For example, the actuation of the second section may be through the linear actuator 315 shown in the figures.

The third column 300 is distinct and spaced by a non-zero amount from both the first column 255 and the second column 275.

Preferably, the variable footprint frame does not comprise any other support columns other than the first column, the second column and the third column. In other words, the weight of the apparatus 201, and of any container associated therewith, is discharged towards the ground passing only through the first column, the second column and the third column.

Additionally, the apparatus 201, when in use, only touches the ground through the first idle wheel, the second idle wheel, and the tractor when the apparatus 201 is connected to the tractor (alternatively, the apparatus 201 may be momentarily supported by a stand and/or a variable extension support foot).

The variable footprint frame comprises a connection arrangement connecting the second column 275 and the third column 300 to the first column 255 and is configured, for example thanks to actuators and linkages and/or joints, to move at least one of the three columns with respect to another of the three columns between a first position (in which the apparatus 201 has a predetermined footprint in plan), e.g., wherein the footprint in plan of the apparatus 201, i.e., of the variable footprint frame, is maximum, and a second position, wherein the footprint in plan of the apparatus 201, i.e., of the variable footprint frame, in said second position is smaller than the footprint in plan of the apparatus 201 in said first position.

It should be noted that the footprint in plan is the width and length of the frame from a plan viewpoint. Alternatively, this footprint in plan can be understood as the area of a triangle lying on a horizontal plane and the vertices thereof are positioned in the respective columns.

The first position of the connection arrangement is the one that must be assumed to achieve the operating configuration of the apparatus 201 in which it allows to transport a container, while the second position must be assumed to achieve the transport configuration of the apparatus 201.

In the first position, the container to be lifted, or lowered, or which is kept lifted by the apparatus 201, is interposed (directly) between the first column, the second column and the third column.

The direction in which to measure the width of the apparatus 201 may also be defined as the direction of the horizontal distance between the second column 275 and the third column 300 when the connection arrangement is in the first position.

In the illustrated embodiment, the connection arrangement is configured to move the third column 300 (with respect to the second column 275 and the first column 255) between a first position, wherein the distance (horizontal and minimum) of the third column 300 from the first column 255 is maximum, and a second position, wherein the distance (horizontal and minimum) between the third column and the first column is minimum, and the third column is located at a shorter distance from the first column than the distance of the second column from the first column.

For example, in such second position, the third column is interposed between the first column and the second column.

When passing from one position to another, only the third column is moved with respect to the two, which always remain at a predetermined distance from each other.

In practice, the connection arrangement is configured to bring the third column and the first column closer to and further away from each other, for example by placing at least one of them in rotation with respect to a vertical axis of rotation.

In the first position, the distance of the third column from the first column is approximately equal to the distance of the second column from the first column, i.e., the distance of the third column from the first column is comprised between + and −20% of the distance of the second column from the first column. In the illustrated embodiment, in the first position the distance of the third column from the first column is equal to the distance of the second column from the first column.

Further, in the first position, the second column and the third column are aligned along a direction perpendicular to a vertical centreline plane of the apparatus 201 passing the first column (said centreline plane being detectable when the connection arrangement is in the first position). This centreline plane also divides the container into two when it is handled by the apparatus 201.

In a preferred embodiment of the connection arrangement illustrated in the figures, the connection arrangement comprises a first crosspiece 320, for example with a straight course, which is provided with a first end 320a rigidly fixed (without residual degrees of freedom) to the first column 255, i.e., to a top portion (of the upper section) of the first column 255, and an opposite second end 320b to which the second column 275, i.e., to a top portion (of the upper section) of the second column 275, is hinged with respect to a vertical axis of rotation R2.

For example, the first crosspiece is arranged horizontally.

The first crosspiece 320 is preferably telescopic so as to be able to vary a horizontal distance between its first end 320a and its second end 320b. This makes it possible to vary the horizontal distance between the first column 255 and the second column 275 and thus improve the compactness of the variable footprint frame.

Thus, the first crosspiece may comprise a first section comprising the first end 320a and a second section comprising the second end 320b that is movable with respect to the first section along a straight axis by means of a linear actuator 325.

The first crosspiece comprises only said ends and is directly connected only to the first column and to the second column.

In said illustrated embodiment, the connection arrangement also comprises a second crosspiece 330 provided with a first end 330a rigidly fixed (without residual degrees of freedom) to the second column 275, that is, to the top portion (of the upper section) of the second column 275, and an opposite second end 330b rigidly fixed (without residual degrees of freedom) to the third column 300, that is, to a top portion (of the upper section) of the third column 300.

The second crosspiece comprises only said ends and is directly connected only to the third column and the second column.

For example, the second crosspiece is arranged horizontally.

In the embodiment illustrated in FIGS. 1-7, the second crosspiece is preferably inextensible.

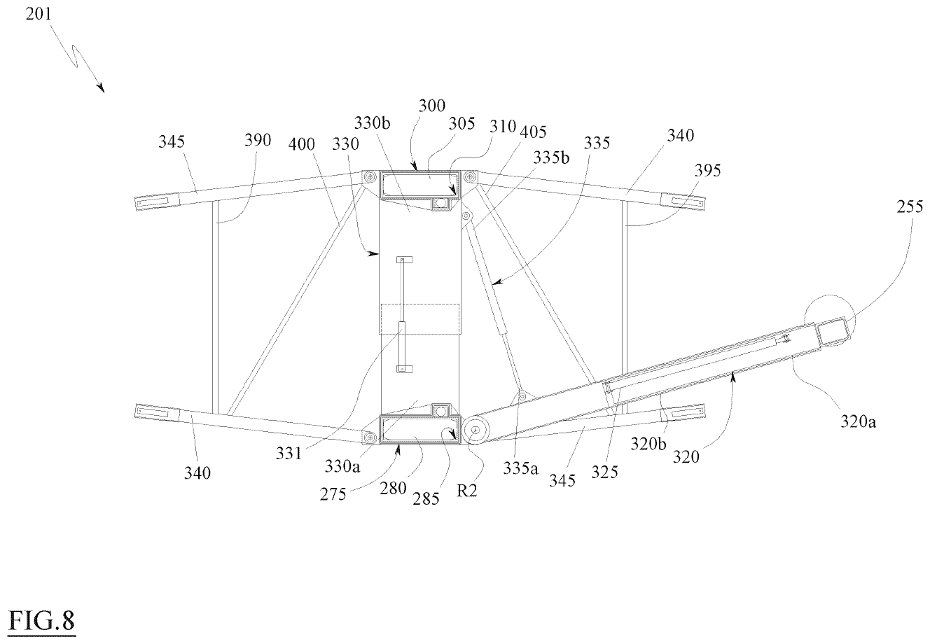

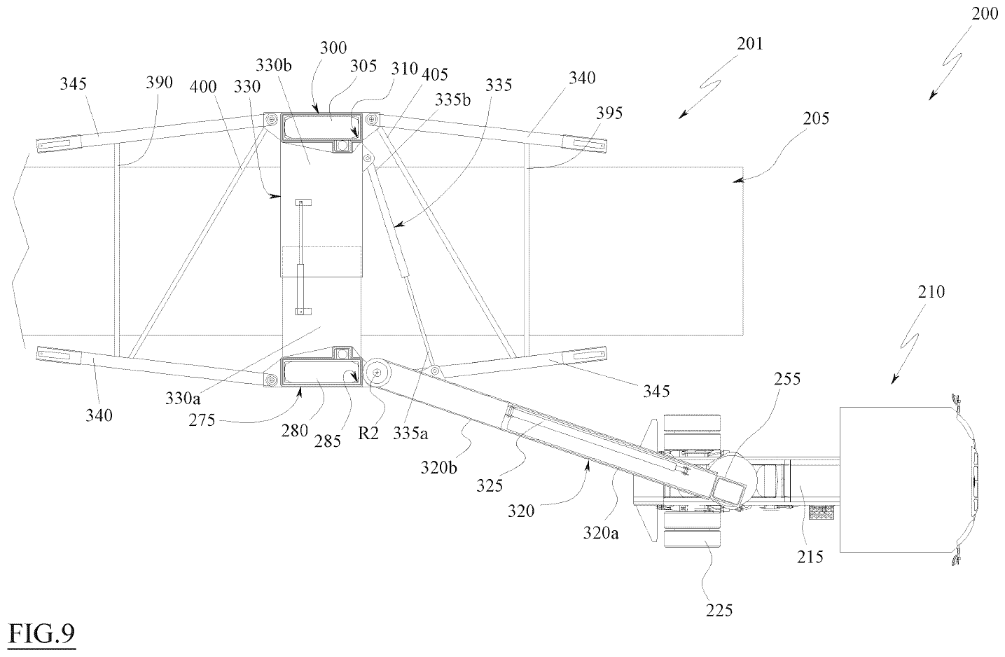

In the embodiment of the apparatus illustrated in FIGS. 8 and 9, instead, the second crosspiece is telescopic so as to be able to vary a horizontal distance between its first end and its second end. In such a case, as illustrated in FIG. 8, the second crosspiece also comprises a linear actuator 331 configured to vary said horizontal distance between the aforesaid first and second end.

The first and the second crosspiece are placed at such a vertical height that they are entirely above the handled container, without interfering with it.

The connection arrangement further comprises an actuator 335 configured to move the third column in rotation with respect to said axis of rotation R2 and with respect to the first crosspiece, that is to move the second crosspiece 330, to which the third column is rigidly fixed, with respect to the axis of rotation R2 and with respect to the first crosspiece. The rotation of the third column with respect to the axis of rotation R2 by means of the actuator 335 allows the connection arrangement to be operated between the first position and the second position of the connection arrangement.

Said rotation of the third column with respect to the axis of rotation R2, if combined with a rotation of the first column about its axis of rotation R1, further makes it possible to arrange the tractor 210 laterally with respect to the apparatus 201 and therefore alongside the container 205, as illustrated in FIG. 9.

The system can therefore be used to lift and handle loads that are longer than an ISO container, for example even longer than the system itself, by positioning the second crosspiece perpendicular to a longitudinal axis of the load and the tractor placed in plan alongside the load, making it move forward or backward along a trajectory parallel to the longitudinal axis of the load.

For example, the actuator 335 is a linear actuator provided with a first end 335a hinged to one between the first column 255 and the first crosspiece 320 and an opposite second end 335b hinged to one between the third column 300 and the second crosspiece 330. The actuator comprises a first portion provided with the first end and a second portion provided with the second end and movable with respect to the first portion along a straight axis. Such a straight axis preferably lies on a horizontal axis.

Specifically, in the embodiment illustrated in FIG. 1, the first end 335a is hinged to the first crosspiece and the second end 335b is hinged to the second crosspiece.

The actuator is preferably of the oleopneumatic type.

For example, the first and second crosspiece may be straight.

In the second position, the first and second crosspiece have longitudinal axes incident to each other, and in the second position, the first and second crosspiece have longitudinal axes substantially parallel to each other.

In an alternative, less preferred embodiment of the connection arrangement, the third column could be connected directly with a telescopic crosspiece to the first column and the second column could be connected with a rigid crosspiece, not variable in length, to the first column.

The variable footprint frame is rigid, i.e. not deformable under normal working loads. In other words, the columns and the crosspieces of the variable footprint frame are rigid. Connected to the variable footprint frame is a lifting arrangement for lifting the container (with respect to the ground, i.e., with respect to a vertical height of the wheels), i.e., configured to allow the container to be lifted, kept lifted and lowered.

Said lifting arrangement is provided with a first portion (directly) connected to the second column and a second portion (directly) connected to the third column.

Each of said portions is provided with a coupling element, or lower support of the container, operable at least along a vertical direction for lifting, keeping lifted and lowering, the container.

In the illustrated embodiment, both the first portion and the second portion of the lifting arrangement each comprise a pair of arms, wherein a first arm 340 and a second arm 345 are hinged to the respective column, preferably idly, with respect to a corresponding vertical hinge axis (different for the two arms) and develop along respective longitudinal directions transverse to the corresponding hinge axis, for example horizontally in a direction away from the respective column.

Each portion of the lifting arrangement comprises a respective gripping body 350,370, i.e., a first coupling body, of the container and a respective actuation arrangement of said first gripping body configured to move it vertically.

In the illustrated embodiment, each actuation arrangement comprises a rope 355,375 at least partially wrapped around a (idle) wheel 360,380 hinged to the respective arm 340,345 and operated by means of a respective actuator 365,385, for example a linear actuator, to which respective rope the respective gripping body is associated.

The gripping body may for example be a hook.

It is not excluded that in an alternative embodiment, the actuation arrangements may comprise linear actuators provided with one end associated (e.g. rigidly or hinged) with the respective arm and an opposite end to which the respective gripping body is connected (e.g. rigidly or hinged). In such an embodiment, the gripping body could be a fork of the type used in forklifts, or a hook.

In a non-illustrated embodiment, the lifting arrangement may comprise at least two pairs of forks, wherein one pair is rigidly connected to the upper section of the second column and the other pair is rigidly connected to the upper section of the third column. In this way by means of the telescopic columns it is possible to lift a container while pushing it from below, after having inserted the forks underneath the container.

The illustrated lifting arrangement comprises a first spacer bar 390 and a second spacer bar 395 removably associable with respective arms facing each other of the lifting arrangement, so as to prevent rotation of said arms with respect to the hinge axes.

In particular, the first spacer bar has a first end connected to the first arm of the first portion of the lifting arrangement and an opposite second end connected to the second arm of the second portion of the lifting arrangement and is directly interposed between them.

The spacer bars are rigid, i.e., not deformable under normal working loads to which they are subjected. In particular, these bars only work in traction and compression under forces applied to them by the arms between which they are interposed.

The lifting arrangement may comprise, in addition to the first and second spacer bar, a third spacer bar 400 and a fourth spacer bar 405 that extend from one between the second column and the third column toward the arms of the portion of lifting arrangement associated with the opposite column.

The apparatus 201 may comprise a pump (not illustrated) driven by a motor (not illustrated) and operatively connected to the connection arrangement for moving the first column between the first and the second position, i.e., for powering the actuator of the connection arrangement.

As can be guessed, such a pump can also be used to power other actuators that may be present when certain elements are telescopic, such as the columns, for example.

These pumps and motor are smaller in size than those of the prior art devices, as they need to power only the drives of the variable geometric frame and do not need to also drive the wheels to move the frame.

Said pump and said motor are connected to one of the three columns or to the connection arrangement.

The operating configuration of the apparatus 201, i.e. of the variable footprint frame, occurs when the connection arrangement is in the first position and all the telescopic columns are in one of their position of maximum longitudinal extension.

In the illustrated embodiment, the operating configuration occurs when the connection arrangement is in the first position, all telescopic columns are in their position of maximum longitudinal extension, the idle wheels protrude at least one-third from the cavity and the spacer bars are interposed between the arms of the lifting arrangement.

The operating configuration coincides with when the connection arrangement is in the first position only in the less preferred embodiment in which the columns are not telescopic, the wheels are not within cavities made in the columns and are movable with respect to said cavities, and the lifting arrangement comprises forks that are vertically movable along the columns instead of hinged arms.

The transport configuration of the apparatus 201, i.e. the variable footprint frame, occurs when the connection arrangement is in its second position and all the telescopic columns are in one of their position of minimum longitudinal extension.

In the illustrated embodiment, the transport configuration occurs when the connection arrangement is in the second position, all telescopic columns are in their position of minimum longitudinal extension, the idle wheels protrude less than a quarter from the cavity, the first crosspiece is in its position of minimum longitudinal extension, and the spacer bars are not interposed between the arms of the lifting arrangement.

The transport configuration coincides with when the connection arrangement is in the second position only in the less preferred embodiment in which the columns are not telescopic, the first crosspiece is not telescopic, the wheels are not within cavities made in the columns and are movable with respect to said cavities, and the lifting arrangement comprises forks that are vertically movable along the columns.

The apparatus 201 illustrated can be connected to any tractor, i.e. a tractor of an articulated truck, provided it has a fifth wheel. Alternatively, it is possible to assume the use of a special tractor, provided with the fifth wheel (or alternatively with an arrangement for fixing the apparatus comprising a pin or a circular seat that allow to removably associate the apparatus 201 to the special tractor, forming a rotoidal pair with a vertical axis of rotation with the first column of the apparatus 201. For example, such a tractor could be an adapted forklift or other self-propelled industrial vehicle.

The system, in order to facilitate loading the apparatus onto the carriage to allow it to be transported when the apparatus is in a transport configuration, may comprise a stand 311 having a pair of horizontal, telescopic upper crosspieces that are positioned side-by-side and parallel to each other and are configured to extend and retract while the connection arrangement is operated between the first and the second position by inferiorly supporting the first and the second crosspiece and following them in the movement leading to the passage between the second and the first position.

The operation of the system 200 according to the invention is as follows.

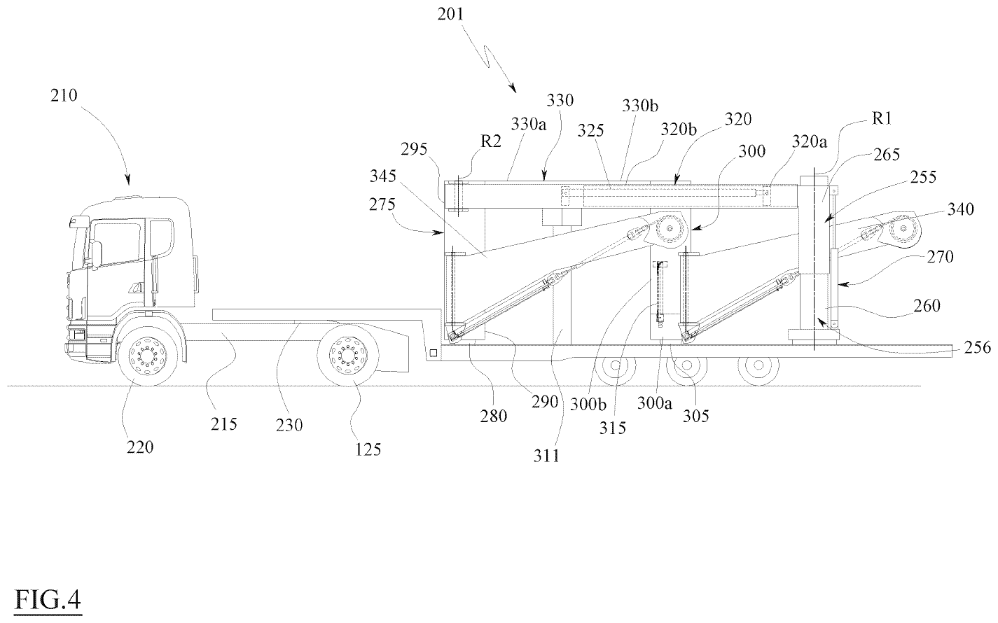

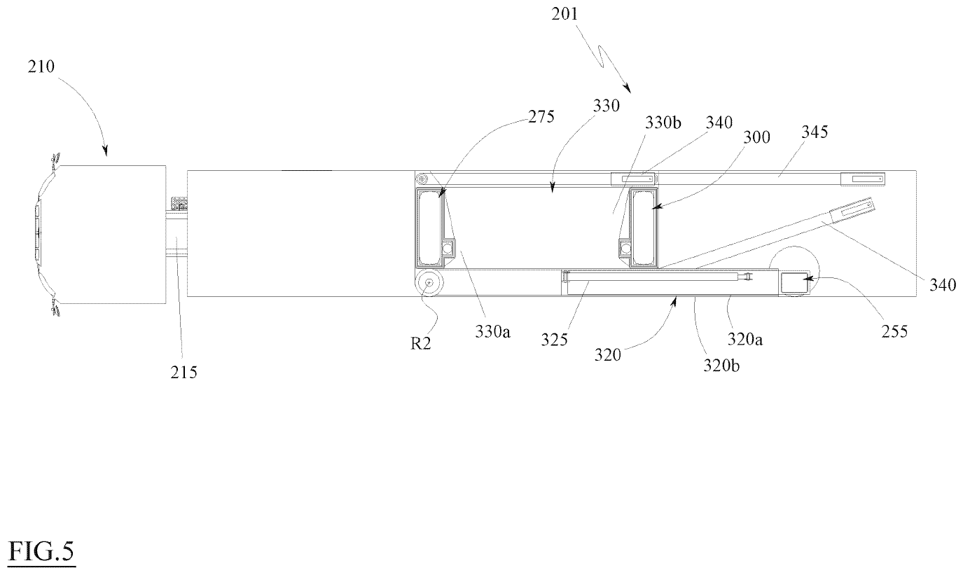

The apparatus 201 is transported in a transport configuration positioned above a carriage pulled by a tractor that takes it where it is supposed to be used to handle containers (see FIGS. 4 and 5).

Once they have reached destination, the apparatus 201 is brought from the transport configuration into the operating configuration supporting it during this transition, for example by placing it on the special stands, such as for example the stand 311 or by means of a forklift or by lifting it by means of a crane.

First of all, in the passage from the transport configuration to the operating configuration, the drive of the connection arrangement that places the second crosspiece 330 in rotation with respect to the vertical axis of rotation R2 is operated in order to bring it from the second position into the first position. After that, the first column 255 can already be connected to the fifth wheel 230 of the tractor.

If the columns are telescopic, like the one illustrated, the columns and possibly also the first crosspiece are extended.

Also in the illustrated case, in which the lifting arrangement comprises the arms 340,345, from the position visible in plan in FIG. 5, they are to be rotated with respect to the respective hinge axes so that in each pair of arms they both protrude in diametrically opposite directions away from the respective column to which they are hinged. These directions are substantially parallel to the forward direction of the system when the apparatus 201 is connected to the tractor, that is parallel to the median plane of the apparatus 201 when it is in the first position. Further, after positioning the arms, they are locked in place by means of the spacer bars 390,395,400,405 which are fixed to them. Once the apparatus 201 is in operating configuration and connected to the tractor, the apparatus 201 is moved by the tractor at the container to be lifted, positioning it so that the container is between the first column, the second column and the third column.

In the illustrated embodiment, the container is also interposed in plan between the arms of the first portion of the lifting arrangement and the arms of the second portion of the lifting arrangement.

At this point, the container is grasped by the gripping bodies of the lifting arrangement and lifted so that it does not touch the ground or the carriage on which the container is placed.

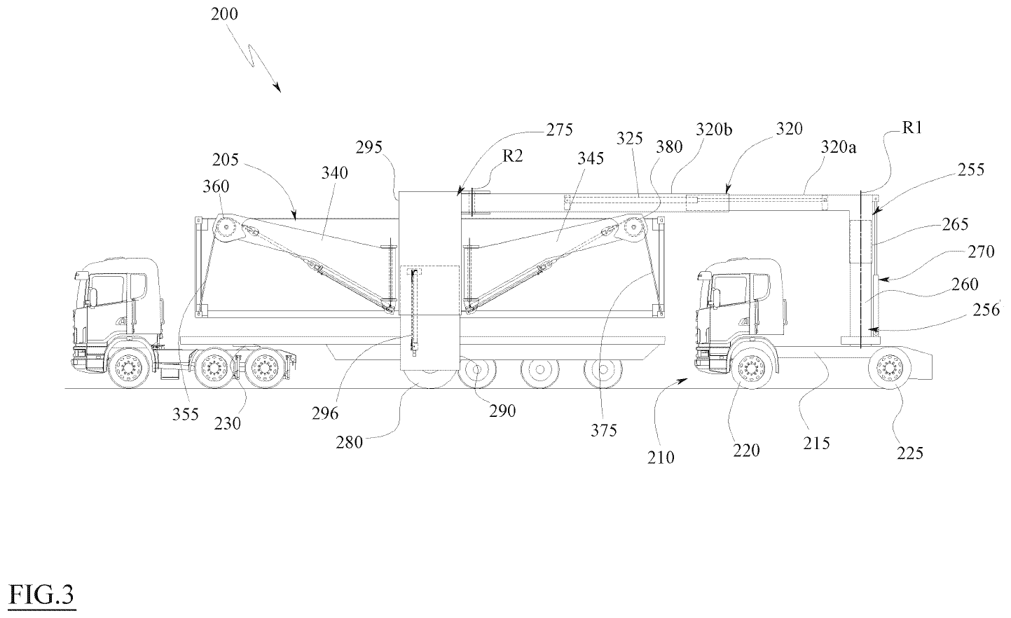

While the apparatus 201 keeps the container lifted, the tractor moves the apparatus 201 to the place where the container is to be unloaded, i.e. lowered. For example, thanks to the first telescopic column, the first crosspiece can be placed at a higher height than a portion of the top of the tractor, so that the tractor can be oriented such that the second and the third column, and hence the lifting arrangement, are in front of the cockpit (as illustrated in FIG. 3).

Once the apparatus 201 has completed its work, it can be brought back from the transport configuration to store it on the working place or take it to another place (working or storage).

In the case of the illustrated apparatus 201, the first step is to remove the spacer bars, after which, or if the apparatus 201 is not the illustrated apparatus, the drive of the connection arrangement is operated to move it from the first position to the second position.

If the columns and the first crosspiece are telescopic like in the case illustrated, they are also brought to their position of minimum longitudinal extension.

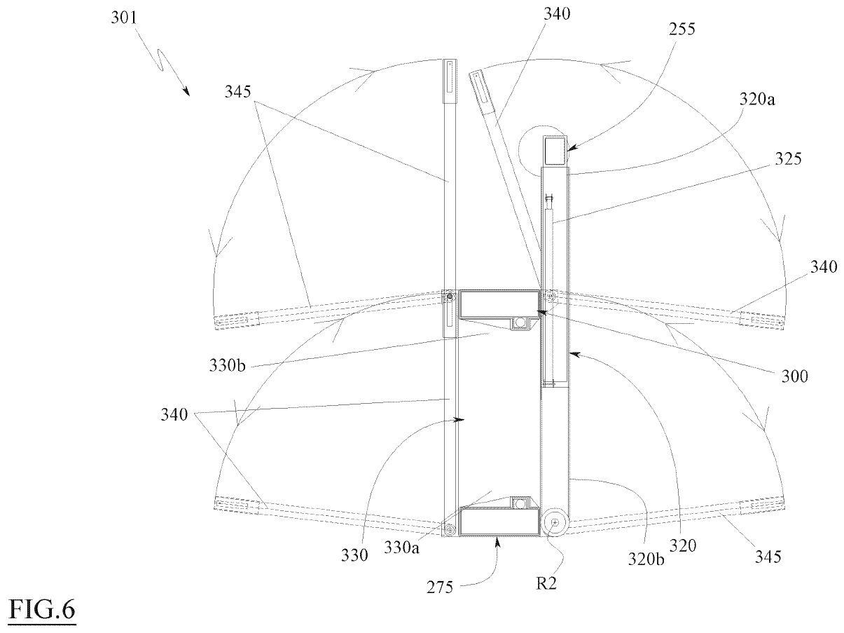

The arms shall be rotated with respect to the respective hinge axes as illustrated in FIG. 6, i.e. so that they are aligned two by two (thus within the single pair of arms) with respect to a direction transverse to a direction running from the second column to the first column when the connection arrangement is in the second position.

Since in this configuration the arms are free to move, it is advisable to fasten them to the rest of the variable footprint frame by means of ropes.

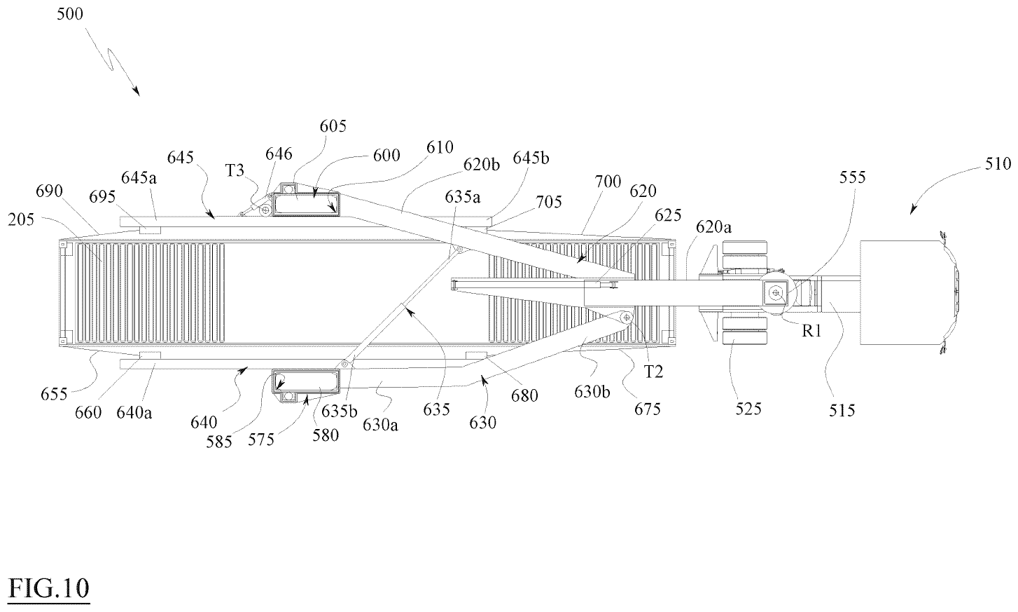

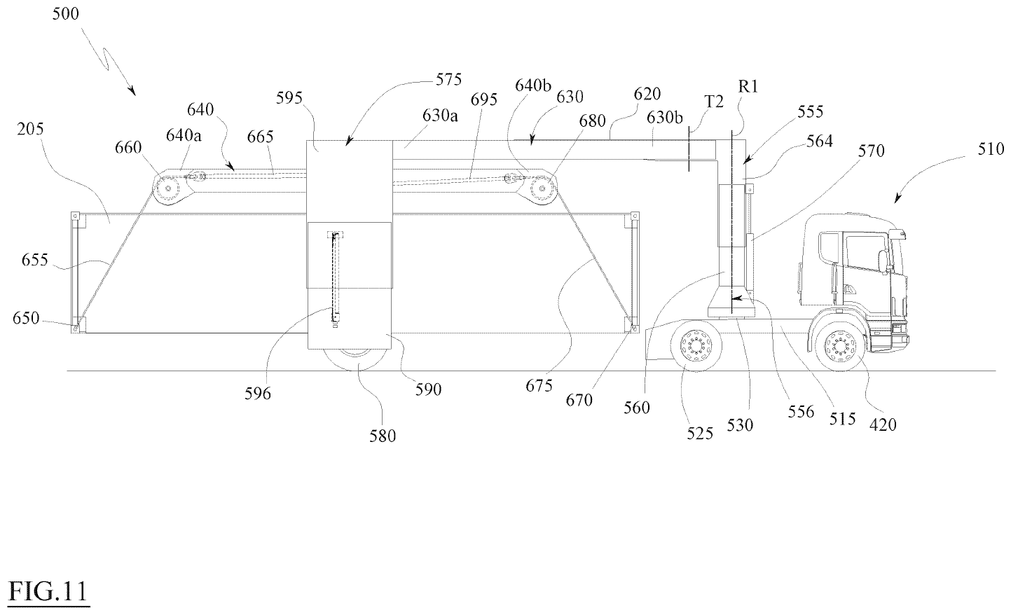

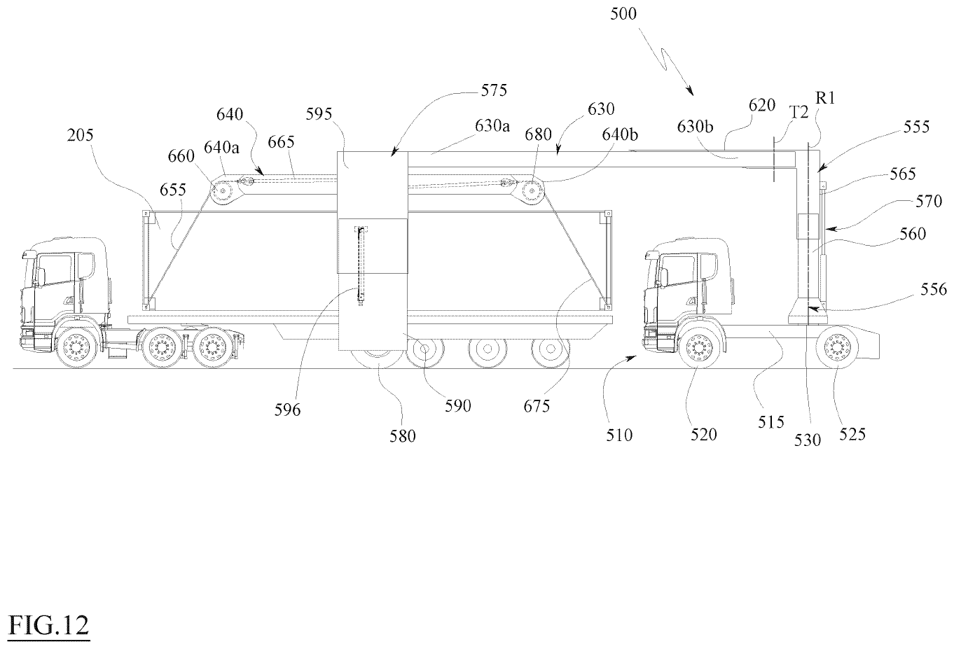

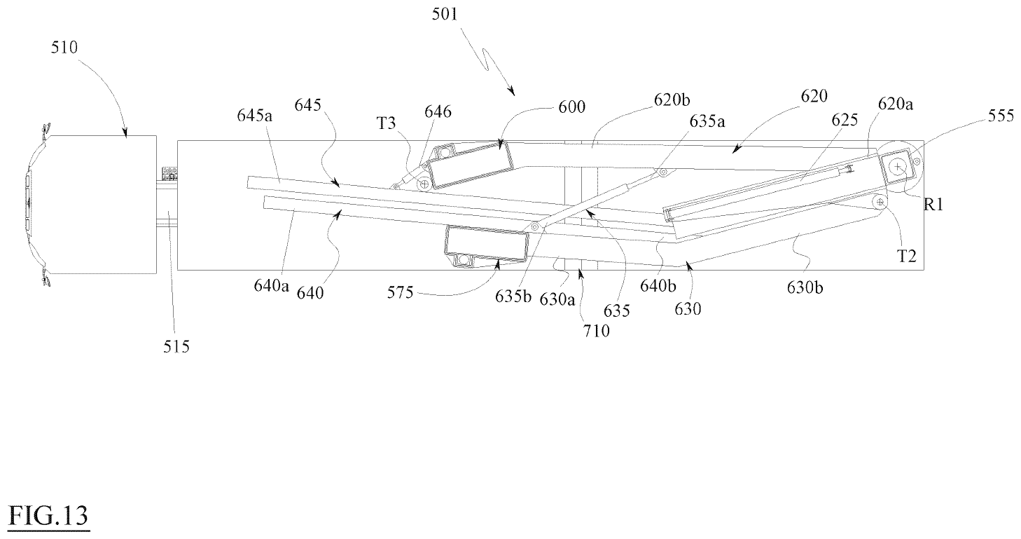

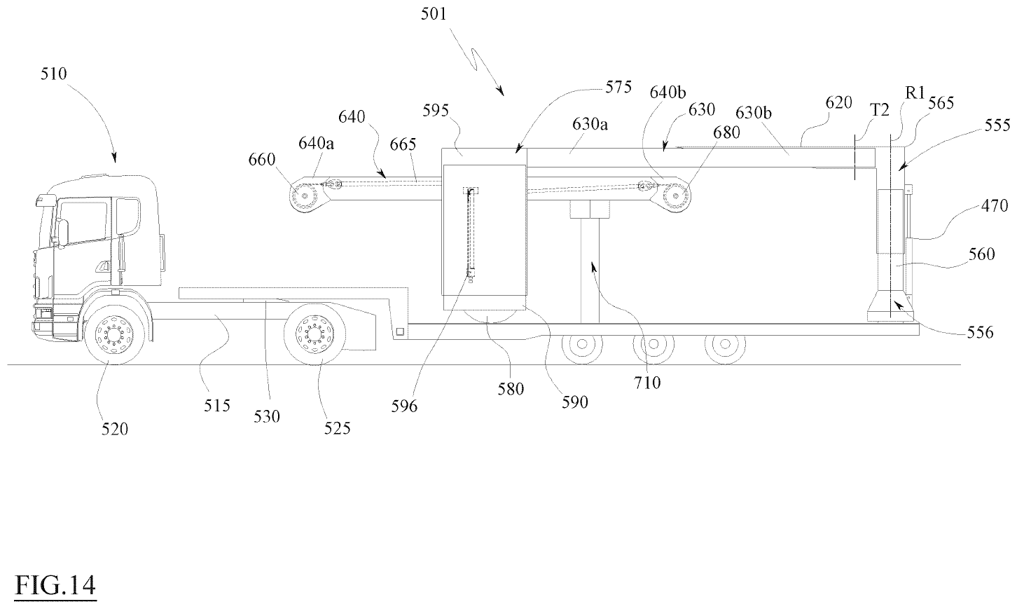

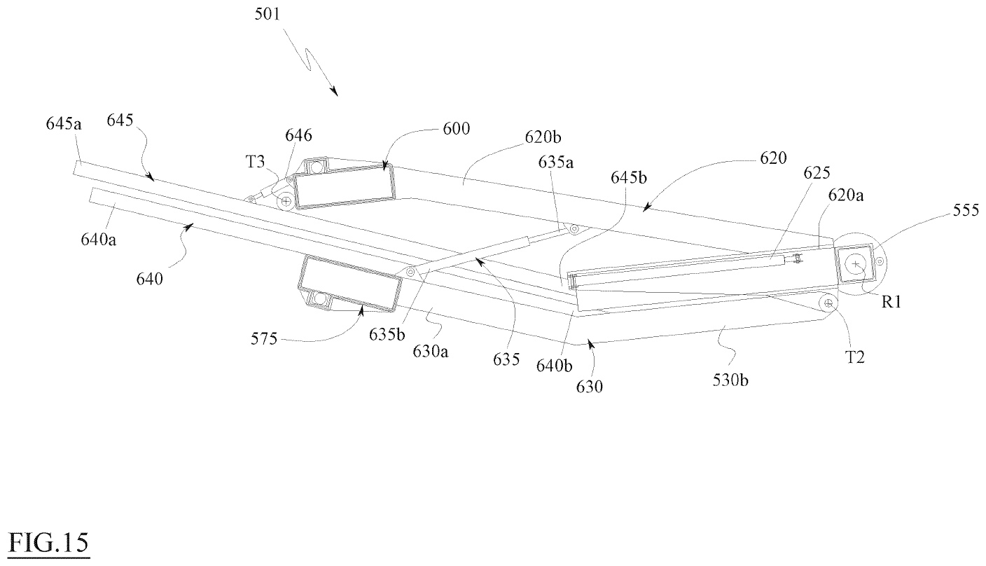

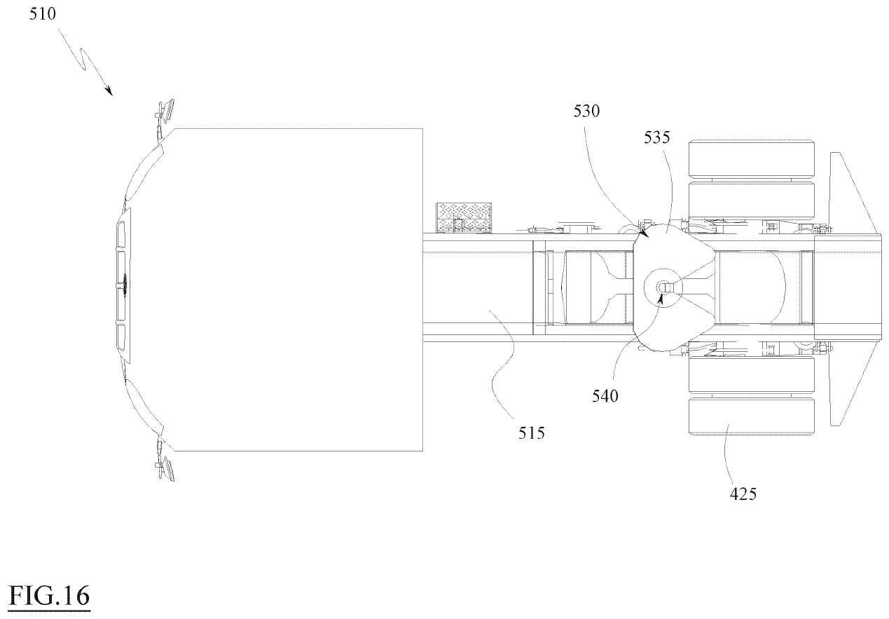

With particular reference to FIGS. 10-16, a system for handling containers 205 (ISO containers), in particular of the type capable of moving autonomously along roads and motorways open to the public, has been globally indicated with 200. In the illustrated embodiments, there is a system 200 capable of handling a single container, however, with appropriate dimensional modifications of the system well within the reach of the person skilled in the art, the inventive concept underlying the system can be adapted to transport two containers stacked vertically one on top of the other.

The container 205 that can be handled by the system is preferably an ISO container (provided with coupling elements, for example in the form of pins and/or slots), adapted to be grasped by the system 200, for example by means of hooks.

The system 500 comprises a tractor 510, i.e., a self-propelled vehicle suitable for land transportation, which comprises a frame 515 to which at least one pair of drive and steering wheels 520 or one pair of drive wheels and one pair of steering wheels (and possibly, generally, also at least one pair of idle wheels 525) are associated.

The tractor illustrated is that of an articulated vehicle, i.e. a self-propelled vehicle adapted to transport carriages resting on the ground by means of idle wheels, however it is not excluded that the tractor may be another self-propelled vehicle, such as a forklift.

It is specified that a carriage is defined as a frame having a flat upper surface for supporting goods, for example a container, and to which a plurality of ground support wheels, all of which are idle wheels, is associated. In practice, the carriage needs a tractor to be moved.

The tractor 510 comprises a motor (not illustrated), for generating the force necessary for the drive wheels to move the tractor, and a transmission (in the case where the motor is endothermic) for carrying the energy of the motor to the drive wheels.

The tractor 510 further comprises a steering system (not illustrated), for controlling the steering wheels or the steering and drive wheels, and a cockpit adapted to accommodate a tractor operator and controls for operating said tractor systems.

The tractor 510 comprises a fifth wheel 530 (internationally known) associated with the frame of the tractor and which is adapted to allow the removable connection of a carriage to be towed and which inferiorly supports a portion of said carriage.

Specifically, the fifth wheel 530 comprises a plate, provided with a substantially flat upper surface 535 (which is generally lubricated to reduce friction with the portion of the carriage placed on top of it), in which plate a recess 540 adapted to allow the insertion of a pin of the carriage, is made.

The fifth wheel then comprises a locking mechanism configured to selectively retain and release a pin (of the carriage) inserted inside the recess.

The cockpit is positioned in a front portion of the tractor, while the fifth wheel 530 is positioned in a rear portion of the tractor.

The system 200 further comprises a variable footprint handling apparatus 501,501′ (hereinafter abbreviated as apparatus 501,501′) for handling containers 205. In particular, the handling performed by the apparatus involves lifting, lowering and keeping the container suspended from the ground. By connecting the apparatus to the tractor 510, as will become clearer in the following, it then becomes possible to handle the container by moving it horizontally in space while the apparatus keeps the container suspended in the air.

The apparatus 501,501′ is a variable footprint apparatus as it is able to vary its footprint between a working (or operating) configuration, in which it is possible to lift/lower and keep lifted a container (or a pair of containers) and a storage or transport configuration, in which the maximum overall footprint of the apparatus 501,501′ is reduced compared to the working configuration.

It is specified that variable footprint means the possibility of varying at least one of its dimensions in the space between height, width and length. Width and length are perpendicular to each other and lie on a horizontal plane, whereas the height is measured vertically. Further, in this discussion, width will be used with reference to a measurement direction perpendicular to a straightforward direction of the tractor, in a condition where the apparatus 501,501′ is connected to and aligned with the tractor (as is visible in the figures), and the length with reference to a measurement direction parallel to the straightforward direction of the tractor and perpendicular to the length.

The maximum overall footprint may be considered as the volume of the smallest parallelepiped that entirely contains the apparatus 501,501′.

The apparatus 501,501′ comprises a variable footprint frame, also definable as “with variable geometry”, adapted to be removably connected to the tractor 510, namely to the fifth wheel 530 of the tractor, to be moved by it.

In the illustrated embodiment, the frame is capable of varying its footprint in all three indicated directions (height, width and length). However, it is not excluded that in a non-illustrated, and less preferred embodiment, the frame is capable of varying its footprint only in the direction of its width or in the direction of width and length, but not in height. The variation in frame footprint allows the apparatus 501,501′ to be operated between the operating configuration, in which it is capable of handling a container, i.e. lifting, lowering and keeping it suspended, and the transport or storage configuration, in which the apparatus 501,501′ is adapted to be transported on the carriage of an articulated truck, i.e. a carriage connected to a tractor. In the transport configuration, the apparatus 501,501′ is not configured to handle a container.

In the operating configuration the footprint of the frame (and of the apparatus 501,501′) is maximum, while it is minimum in the transport or storage configuration.

Said variable footprint frame comprises a first column 555, which is vertical, i.e., it develops mainly longitudinally along a vertical axis, and is adapted to be removably connected to the tractor. In particular, the apparatus 501,501′ is connected to the tractor only through the first column.

The first column 555 is adapted to be associated, i.e., is associated, idly with the fifth wheel 530 of the tractor so that the first column can rotate with respect to the tractor with respect to a vertical axis of rotation R1. Alternatively, the column may comprise a rigidly fixable lower portion, i.e., rigidly fixable without residual degrees of freedom, to the fifth wheel 530 and the remainder of the first column is rotatably associated with respect to said lower end with respect to the vertical axis of rotation R1.

For the connection to the fifth wheel, the first column comprises a coupling arrangement located at a lower end 556 of the first column.

Such a coupling arrangement may, for example, be the one known to a person skilled in the art for fixing a carriage to the fifth wheel of the tractor and may comprise a pin (not illustrated) adapted to be inserted into the recess 540 of the fifth wheel 530. Obviously, it cannot be excluded that, as an alternative to the fifth wheel, the tractor could comprise a system for the ad hoc connection of the first column. In such a case, the tractor could, for example, comprise a vertical pin on which a lower portion of the first column is fitted so as to realize a rotoidal pair with a vertical axis of rotation R1.

In the illustrated embodiment, the first column is of a telescopic type and capable of varying its longitudinal extension along a vertical direction.

Thus, the first column comprises a lower section 560 that comprises the lower portion of the first column and an upper section 565 that is movable with respect to the lower section along a vertical direction, such as by means of a linear actuator 570.

The variable footprint frame then comprises a second column 575 (vertical, i.e., developing longitudinally along a vertical axis) to which a first idle ground support wheel 580 is associated idly. In practice, the second column rests on the ground (only) by means of the first idle wheel which is connected to a lower end of the second column.

The first idle wheel 580 is rotatably associated with the second column 575 at least with respect to a horizontal axis of rotation. It is not excluded that the first idle wheel 580 may be rotatably associated idly with the second column 575 also with respect to a vertical axis of rotation, for example coaxial to a longitudinal axis of the column.

The first idle wheel 580 may be, at least partially, vertically aligned with the second column. Preferably, the second column entirely overlaps in plan the first idle wheel.

In the illustrated embodiment, in order to further reduce the footprints, the second column comprises a cavity 585 within which the first idle wheel 580 is at least partially contained. For example, the second column could also comprise a drive configured to selectively let the first idle wheel protrude from the cavity (so that at least one-third of the wheel protrudes) and to let it retract into the cavity (so that less than one-quarter of the wheel protrudes from the cavity), so as to allow a further reduction in footprints and at the same time allow obstacles to be overcome when the wheel is caused to protrude.

It is not excluded that the second column may comprise more than one ground support wheel idly hinged to the second column.

In the embodiment illustrated, the second column is of a telescopic type and capable of varying its longitudinal extension along a vertical direction. In particular, the second column may comprise a lower section 590 to which the first idle wheel 580 is directly associated in the manner described above, and an upper section 595 movable with respect to the lower section 590 along a vertical axis. For example, the actuation of the second section may be through the linear actuator 596 shown in the figures.

The second column 575 is distinct and spaced by a non-zero amount from the first column.

The variable footprint frame also comprises a third column 600 (vertical, i.e., developing longitudinally along a vertical axis) to which a second idle ground support wheel 605 is associated idly. In practice, the third column rests on the ground (only) by means of the second idle wheel which is connected to a lower end of the third column.

The second idle wheel is rotatably associated with the third column 600 at least with respect to a horizontal axis of rotation. It is not excluded that the second idle wheel may be rotatably associated idly with the third column 600 also with respect to a vertical axis of rotation, for example coaxial to a longitudinal axis of the column.

The second idle wheel may be, at least partially, vertically aligned with the third column. Preferably, the third column entirely overlaps in plan the second idle wheel.

In the illustrated embodiment, in order to further reduce the footprints, the third column comprises a cavity 610 within which the second idle wheel is at least partially contained. For example, the third column could also comprise a drive configured to let the second idle wheel protrude from the cavity (so that at least one-third of the wheel protrudes) and to let it retract into the cavity (so that less than one-quarter of the wheel protrudes from the cavity), so as to allow a further reduction in footprints and at the same time allow obstacles to be overcome when the wheel is caused to protrude.

It is not excluded that the third column may comprise more than one ground support wheel hinged idly to the third column.

In the embodiment illustrated, the third column is of a telescopic type and capable of varying its longitudinal extension along a vertical direction. In particular, the third column may comprise a lower section to which the second idle wheel is directly associated in the manner described above, and an upper section movable with respect to the lower section along a vertical axis. For example, the actuation of the second section may be through the linear actuator y shown in the figures.

The third column 600 is distinct and spaced by a non-zero amount from both the first column 555 and the second column 575.

Preferably, the variable footprint frame does not comprise any other support columns other than the first column, the second column and the third column. In other words, the weight of the apparatus 501,501′, and of any container associated therewith, is discharged towards the ground passing only through the first column, the second column and the third column.

Additionally, the apparatus 501,501′, when in use, only touches the ground through the first idle wheel, the second idle wheel, and the tractor when the apparatus 501,501′ is connected to the tractor (alternatively, the apparatus 501,501′ may be momentarily supported by a stand and/or a variable extension support foot).

The variable footprint frame comprises a connection arrangement connecting the second column 575 and the third column 600 to the first column 555 and is configured, for example thanks to actuators and linkages and/or joints, to move at least one of the three columns with respect to another of the three columns between a first position (in which the apparatus 501,501′ has a predetermined footprint in plan), e.g., wherein the footprint in plan of the apparatus 501,501′, i.e., of the variable footprint frame, is maximum, and a second position, wherein the footprint in plan of the apparatus 501,501′, i.e., of the variable footprint frame, in said second position is smaller than the footprint in plan of the apparatus 501,501′ in said first position.

It should be noted that the footprint in plan is the width and length of the frame from a plan viewpoint. Alternatively, this footprint in plan can be understood as the area of a triangle lying on a horizontal plane and the vertices thereof are positioned in the respective columns.

The first position of the connection arrangement is the one that must be assumed to achieve the operating configuration of the apparatus 501,501′ in which it allows to transport a container, while the second position must be assumed to achieve the transport configuration of the apparatus 501,501′.

In the first position, the container to be lifted, or lowered, or which is kept lifted by the apparatus 501,501′, is interposed (directly) between the first column, the second column and the third column.

The direction in which to measure the width of the apparatus 501,501′ may also be defined as the direction of the horizontal distance between the second column 575 and the third column 600 when the connection arrangement is in the first position.

In the illustrated embodiment, the connection arrangement is configured to move at least one between the second column and the third column between a first position, wherein the (minimum and horizontal) distance of the third column from the second column is maximum, and a second position wherein said distance is minimum.

When the connection arrangement is in the first position, the second column and the third column are placed substantially at the same distance (horizontally) from a vertical centreline plane of the apparatus 501,501′ that intersects the first column and is interposed between the second column and the third column.

In the passage between the first position and the second position, the distance of the second column from the first column and the distance of the third column from the first column remain unchanged.

In practice, the connection arrangement is configured to bring the third column and the second column closer to and further away from each other, for example by placing at least one of them in rotation with respect to a vertical axis of rotation.

In the illustrated embodiment, the connection arrangement comprises a first crosspiece 620 provided with a first end 620a connected, for example without residual degrees of freedom, to the first column 555, that is to a top portion (of the upper section) of the first column, and an opposite second end 620b connected, for example without residual degrees of freedom, to the third column 600, that is to a top portion (of the upper section) of the third column.

For example, the first crosspiece is arranged horizontally.

The first crosspiece 620 is preferably telescopic so as to be able to vary a horizontal distance between its first end 620a and its second end 620b. This makes it possible to vary the horizontal distance between the first column 555 and the second column 575 and thus improve the compactness of the variable footprint frame. In particular, as will become clear in the following, the illustrated embodiment combined with the first telescopic crosspiece allows the horizontal distance of the third column and of the second column to be varied with respect to the first column.

Thus, the first crosspiece may comprise a first section comprising the first end 620a and a second section comprising the second end 620b that is movable with respect to the first section along a straight axis by means of a linear actuator 625.

The first crosspiece comprises only said ends and is directly connected only to the first column and to the third column.

The first crosspiece, in order to improve the footprints, is shaped so that from a plan viewpoint the first section is inclined with respect to the second section. For example, the longitudinal axes of these sections intersect and form an obtuse angle (comprised between 90° and 180°) facing the first crosspiece. Basically, the second section develops from the first section in the direction away from the second column.

The connection arrangement also comprises a second crosspiece 630 provided with a first end 630a rigidly fixed (without residual degrees of freedom) to the second column 575, that is to the top portion (of the upper section) of the second column 575, and an opposite second end 630b hinged to one between the first crosspiece, i.e., the second section of the first crosspiece, and the first column, with respect to a vertical axis of rotation T2. In the illustrated embodiment, the second end is hinged to the second section of the first crosspiece, so that it is possible to vary the horizontal distance of the third column and of the second column with respect to the first column through the telescopic element of the first crosspiece.

The second crosspiece comprises only said ends and for example is directly connected only to the second column and to the first crosspiece.

For example, the second crosspiece is arranged horizontally.

In the illustrated embodiment, the second crosspiece is preferably inextensible. However, it is not excluded that in an alternative embodiment it may be telescopic so as to be able to vary a horizontal distance between its first end and its second end.

The first and the second crosspiece are placed at such a vertical height that they are entirely above the handled container, without interfering with it.

The connection arrangement further comprises an actuator 635 configured to move the second column in rotation with respect to said axis of rotation T2 and with respect to the first crosspiece, that is to move the second crosspiece 630, to which the second column is rigidly fixed, with respect to the axis of rotation T2 and with respect to the first crosspiece.

The rotation of the third column with respect to the axis of rotation T2 by means of the actuator 635 allows the connection arrangement to be operated between the first position and the second position of the connection arrangement.

For example, the actuator 635 is a linear actuator provided with a first end 635a hinged to one between the first column 555 and the first crosspiece 620 and an opposite second end 635b hinged to one between the second column 575 and the second crosspiece 630. The actuator comprises a first portion provided with the first end and a second portion provided with the second end and movable with respect to the first portion along a straight axis. Such a straight axis preferably lies on a horizontal axis.

Specifically, in the illustrated embodiment, the first end 635a is hinged to the first crosspiece and the second end is hinged to the second crosspiece.

The actuator is preferably of the oleopneumatic type.

It is not excluded that, in an alternative less preferred non-illustrated embodiment, the connection arrangement may comprise a horizontally arranged telescopic crosspiece connecting the second column to the first column, and which by varying its longitudinal extension allows the first and he second position of the connection arrangement to be achieved by bringing the second column and the third column closer to and further away from each other. This telescopic crosspiece would be perpendicular to a vertical centreline plane passing through the first column and interposed between the second column and the third column.

Connected to the variable footprint frame is a lifting arrangement for lifting the container (with respect to the ground, i.e., with respect to a vertical height of the wheels), i.e., configured to allow the container to be lifted, kept lifted and lowered.

Said lifting arrangement is provided with a first portion (directly) connected to the second column and a second portion (directly) connected to the third column.

Each of said portions is provided with a coupling element, or lower support of the container, operable at least along a vertical direction for lifting, keeping lifted and lowering, the container.

Connected to the variable footprint frame is a lifting arrangement for lifting the container (with respect to the ground, i.e., with respect to a vertical height of the wheels), i.e., configured to allow the container to be lifted, kept lifted and lowered.

Said lifting arrangement is provided with a first portion (directly) connected to the second column and a second portion (directly) connected to the third column.

Each of said portions is provided with a coupling element, or lower support of the container, operable at least along a vertical direction for lifting, keeping lifted and lowering, the container.

The lifting arrangement comprises a first arm 640 connected to the second column 575 and developing transversely thereto along a longitudinal (horizontal) direction, and a second arm 645 connected to the third column and developing transversely thereto along a longitudinal (horizontal) direction. In particular, the arms are each connected to the respective column in a respective central portion thereof, such that longitudinal ends of the arms are distal from the respective column.

At least one of said arms is idly hinged to the respective column to which it is connected with respect to a vertical axis of rotation T3.

For example, the second arm is hinged to the third column according to the vertical hinge axis T3.

The first arm 640 and the second arm 645 are for example straight, preferably they are conformed as straight bars arranged with a horizontal longitudinal axis.

In the illustrated embodiment, the connection arrangement may comprise an actuator 646 configured to place the second arm in rotation with respect to the corresponding vertical hinge axis T3.

As an alternative to the actuators, there may be a mechanism for locking and unlocking the rotation of the arms with respect to the columns.

The connection arrangement further comprises a respective gripping body 650,670 of the container, for example a hook, integral with a respective rope 655,675,690,700 at least partially wrapped around a respective wheel 660,680,695,705, hinged (idly) near a respective end 640a,640b,645a,645b of the arm 640,645 distal from the respective column 575,600 to which the arm is associated and operated by means of a respective actuator 665,695.

The non-illustrated parts connected to the second arm are identical to the corresponding parts connected to the first arm.

It is not excluded that in an alternative embodiment, the actuation arrangements may comprise linear actuators provided with one end associated (e.g. rigidly or hinged) with the respective arm and an opposite end to which the respective gripping body is connected (e.g. rigidly or hinged). In such an embodiment, the gripping body could be a fork of the type used in forklifts, or a hook.

In a non-illustrated embodiment, the lifting arrangement may comprise at least two pairs of forks, wherein one pair is rigidly connected to the upper section of the second column and the other pair is rigidly connected to the upper section of the third column. In this way by means of the telescopic columns it is possible to lift a container while pushing it from below, after having inserted the forks underneath the container.

The apparatus 501,501′ may comprise a pump (not illustrated) driven by a motor (not illustrated) and operatively connected to the connection arrangement for moving the first column between the first and the second position, i.e., for powering the actuator of the connection arrangement.

As can be guessed, such a pump can also be used to power other actuators that may be present when certain elements are telescopic, such as the columns, for example. These pumps and motor are smaller in size than those of the prior art devices, as they need to power only the drives of the variable geometric frame and do not need to also drive the wheels to move the frame.

Said pump and said motor are connected to one of the three columns or to the connection arrangement.

The operating configuration of the apparatus 501,501′, i.e. of the variable footprint frame, occurs when the connection arrangement is in its first position and all the telescopic columns are in their position of maximum longitudinal extension.

In the illustrated embodiment, the operating configuration occurs when the connection arrangement is in the first position, all telescopic columns are in their position of maximum longitudinal extension, the idle wheels protrude at least one-third from the cavity and the spacer bars are interposed between the arms of the lifting arrangement.

The operating configuration coincides with when the connection arrangement is in the first position only in the less preferred embodiment in which the columns are not telescopic, the wheels are not within cavities made in the columns and are movable with respect to said cavities, and the lifting arrangement comprises forks that are vertically movable along the columns instead of hinged arms.

The transport configuration of the apparatus 501,501′, i.e. the variable footprint frame, occurs when the connection arrangement is in its second position and all the telescopic columns are in their position of minimum longitudinal extension.

In the illustrated embodiment, the transport configuration occurs when the connection arrangement is in the second position, all telescopic columns are in their position of minimum longitudinal extension, the idle wheels protrude less than a quarter from the cavity, the first crosspiece is in its position of minimum longitudinal extension, and the spacer bars are not interposed between the arms of the lifting arrangement.

The transport configuration coincides with when the connection arrangement is in the second position only in the less preferred embodiment in which the columns are not telescopic, the first crosspiece is not telescopic, the wheels are not within cavities made in the columns and are movable with respect to said cavities, and the lifting arrangement comprises forks that are vertically movable along the columns.

The apparatus 501,501′ illustrated can be connected to any tractor, i.e. a tractor of an articulated truck, provided it has a fifth wheel. Alternatively, it is possible to assume the use of a special tractor, provided with the fifth wheel (or alternatively with an arrangement for fixing the apparatus comprising a pin or a circular seat that allow to remotely associate the apparatus 501,501′ to the special tractor, forming a rotoidal pair with a vertical axis of rotation with the first column of the apparatus 501,501′. For example, such a tractor could be an adapted forklift or other self-propelled industrial vehicle.

The system, in order to facilitate loading the apparatus onto the carriage to allow it to be transported when the apparatus is in a transport configuration, may comprise a stand 710 having a pair of horizontal, telescopic upper crosspieces that are positioned side-by-side and parallel to each other and are configured to extend and retract while the connection arrangement is operated between the first and the second position by inferiorly supporting the first and the second crosspiece and following them in the movement leading to the passage between the second and the first position.

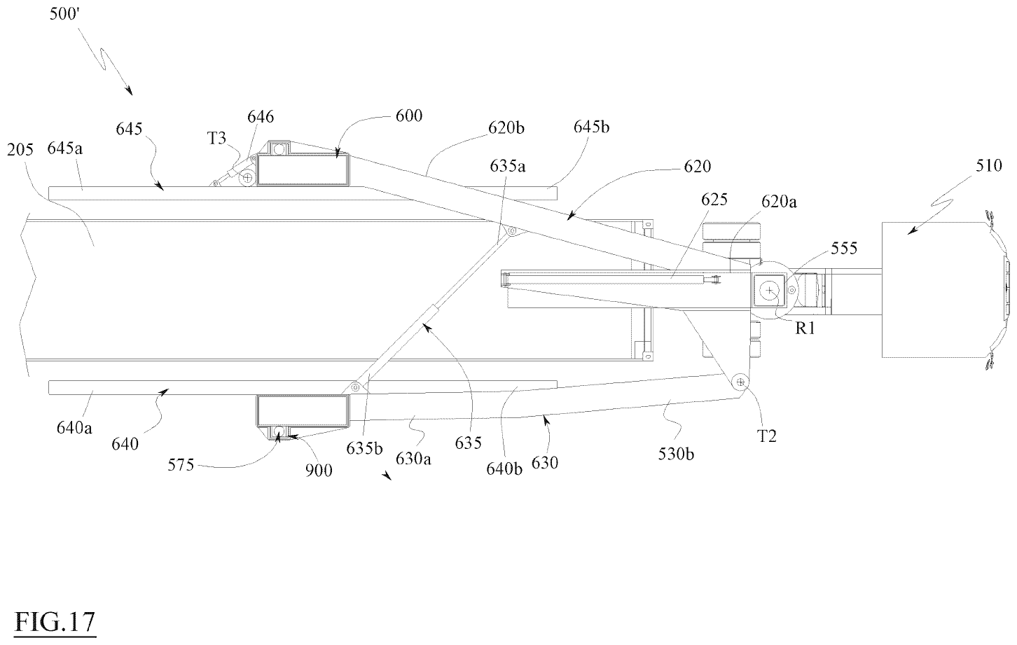

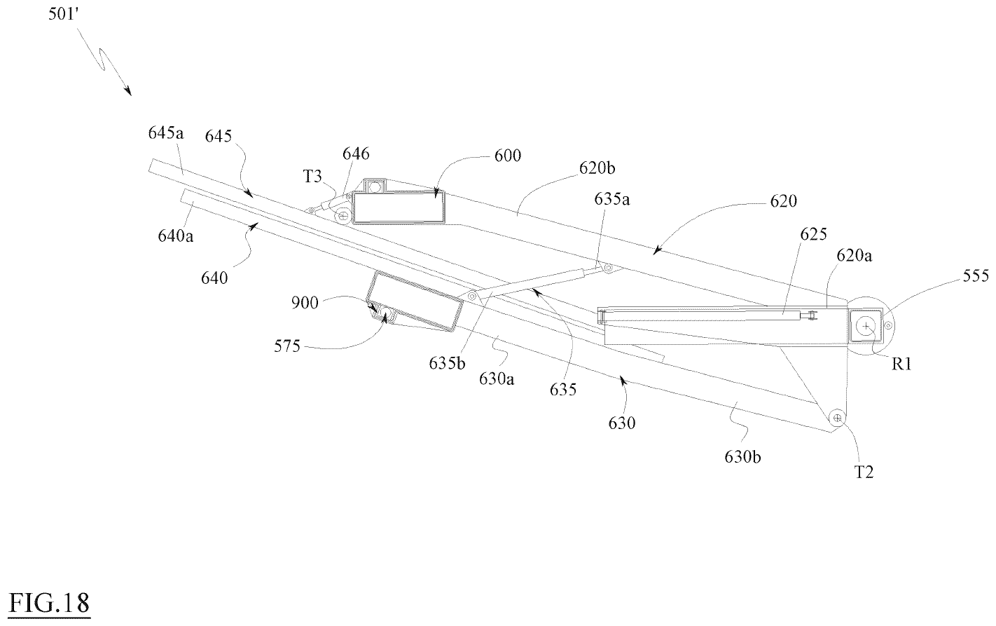

FIGS. 17 and 18 illustrate an alternative embodiment of the system 500′ according to the invention, wherein the apparatus 501′ differs from the apparatus 501 solely in that the second crosspiece is hinged to the first crosspiece by means of an appendage protruding from the first crosspiece along a horizontal direction and transverse to a longitudinal axis of the first crosspiece, i.e., of the first section of the first crosspiece. In particular, said appendage has an extension in the direction in which it protrudes from the first crosspiece that is greater than a maximum width of the first crosspiece measured along a direction transverse to the longitudinal axis thereof.

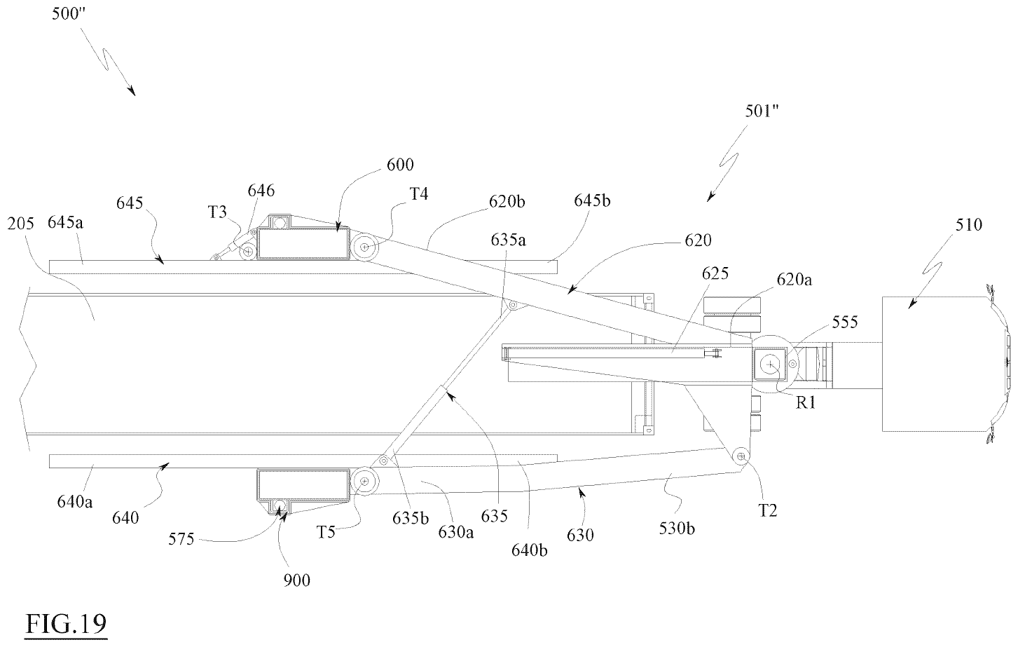

FIG. 19 illustrates yet another embodiment of the system, indicated as 500″, which differs from the system 500′ in that it comprises an apparatus 501″ in which the second end 620b of the first crosspiece may be hinged to the third column, that is to a top portion (of the upper section) of the third column, with respect to a vertical axis of rotation T4, and wherein the first end 630a of the second crosspiece may be hinged to the second column, that is to a top portion (of the upper section) of the second column, with respect to a vertical axis of rotation T5.

In such a case, the apparatus may comprise a first locking mechanism (not illustrated) operable at least between a first position, in which it allows a rotation of the third column with respect to the first crosspiece, and a second position, in which it locks the relative rotation between the first crosspiece and the third column.

Said mechanism may comprise an actuator (not illustrated) configured to move the third column in rotation with respect to said axis of rotation T4, that is to move the third column in rotation with respect to the first crosspiece, and to selectively lock the relative angular position between said third column and first crosspiece.

The apparatus may also comprise a second locking mechanism (not illustrated) operable at least between a first position, in which it allows a rotation of the third column with respect to the first crosspiece, and a second position, in which it locks the relative rotation between the second crosspiece and the second column.

Said mechanism could comprise an actuator (not illustrated) configured to move the second column in rotation with respect to said axis of rotation T5, that is to move the second column in rotation with respect to the second crosspiece, and to selectively lock the relative angular position between said second column and said second crosspiece. It is not excluded that in an alternative embodiment not illustrated, the columns are connected to the crosspieces like in the embodiments 500 and 500′, but the ground support wheels could also be hinged to the respective columns with respect to vertical axes of rotation.

The operation of the system 500,500′,500″ according to the invention is the following. The apparatus is transported in a transport configuration positioned above a carriage pulled by a tractor that takes it where it is supposed to be used to handle containers (see

FIGS. 4 and 5).

Once they have reached destination, the apparatus is brought from the transport configuration into the operating configuration supporting it during this transition, for example by placing it on the special stand 710 or by means of a forklift or by lifting it by means of a crane.

First of all, in the passage from the transport configuration to the operating configuration, the drive of the connection arrangement that places the second crosspiece 630 in rotation with respect to the vertical axis of rotation T2 is operated in order to bring it from the second position into the first position. After that, the first column 555 can already be connected to the fifth wheel 530 of the tractor.

If the columns are telescopic, like the one illustrated, the columns and possibly also the first crosspiece are extended.

Again in the illustrated case, wherein the lifting arrangement comprises the arms 640,645, from the position visible in plan in FIG. 6, they are to be rotated with respect to their respective vertical hinge axes, for example by means of the actuators provided, so that, having reached the first position of the connection arrangement, the arms are arranged with longitudinal axes parallel to each other and parallel to a vertical centreline plane of the apparatus equidistant from the third and second column and intersecting the first column.

Once the apparatus is in operating configuration and connected to the tractor, the apparatus is moved by the tractor at the container to be lifted, positioning it so that the container is between the first column, the second column and the third column.

In the illustrated embodiment, the container is also interposed in plan between the first arm and the second arm, which flank the container laterally.

At this point, the container is grasped by the gripping bodies of the lifting arrangement and lifted so that it does not touch the ground or the carriage on which the container is placed.

While the apparatus keeps the container lifted, the tractor moves the apparatus to the place where the container is to be unloaded, i.e. lowered. For example, thanks to the first telescopic column, the first crosspiece can be placed at a higher height than a portion of the top of the tractor, so that the tractor can be oriented such that the second and the third column, and hence the lifting arrangement, are in front of the cockpit (as illustrated in FIG. 3).

Once the apparatus has completed its work, it can be brought back from the transport configuration to store it on the working place or take it to another place (working or storage).

In the case of the illustrated system, it is possible to place the first and the second crosspiece on the stand 710, which, by means of its telescopic crosspieces, is able to support the crosspieces at the bottom while they pass from the first position to the second position.

If the columns and the first crosspiece are telescopic like in the case illustrated, they are also brought to their position of minimum longitudinal extension.

The second arm 645, as the connection arrangement passes from the first to the second position, is rotated so that it does not touch the first arm, which being connected to the second column rotates about the vertical axis of rotation T2 together with it, with the result that its first end 645a would soon touch the second arm if it were not rotated about the axis T3, for example so as to keep the second arm parallel to the first arm while the first arm rotates about the vertical axis of rotation T2.

In all the embodiments of the apparatus 201,501,501′,501″ described above, it comprises at least one pair of columns.

Said columns 255,275,300,555,575,600 of the pair of columns develop along a respective direction of development (A).

Said direction of development is vertical, i.e. along said vertical axis.

In the case of the embodiments illustrated in the present patent, the apparatus 201,501, 501′,501″ always comprises at least (and preferably) three columns, i.e. a first column 255,555, a second column 275,575 and a third column 300,600.

The three columns develop longitudinally along the respective direction of development A.

As described above, the apparatus 201,501,501′,501″ also comprises at least one crosspiece 320,330,620,630. According to the invention, said crosspiece 320,330,620,630 is configured to connect the columns of the (at least one) pair of columns of the crane.

Said (at least one) crosspiece develops along a (respective) direction of development (B), for example horizontal, transverse to the direction of development (A) of the crane columns.

In all the embodiments of the apparatus 201,501,501′,501″ described above, at least one between a column of the (at least one) pair of columns and the crosspiece (configured to connect said columns of the at least one pair of columns) is of the telescopic type. Preferably, all columns that are telescopic comprise at least one male section 820,260,290,300a, 560,590 and one female section 830,265,295,300b,595.

Further preferably, also all the crosspieces that are telescopic comprise at least one male section 820,320a,330a,620a and one female section 830,320b,330b,620b.

Thus, a one-stage telescopic column is made; it is not excluded that, by adding a section that is female to the female section, a two-stage telescopic column or crosspiece can be obtained.

Said male and female sections, in the case of the columns, correspond respectively to the lower section 260,290,300a,560,590 and to the upper section 265,295,300b,595 described above. In the case of crosspieces, the male section corresponds to the first ends 320a, 330a,620a and the female section corresponds to the second ends 320b,330b,620b.

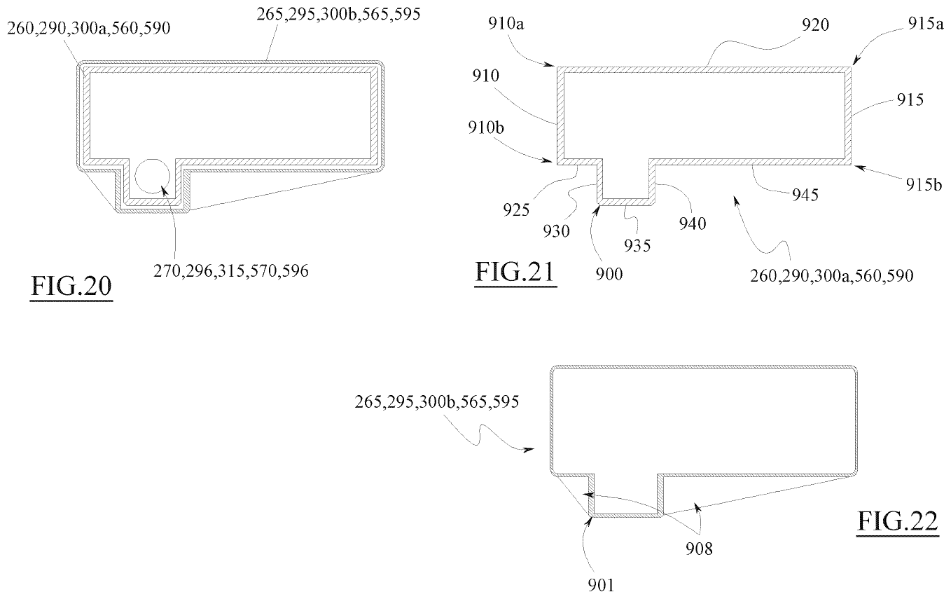

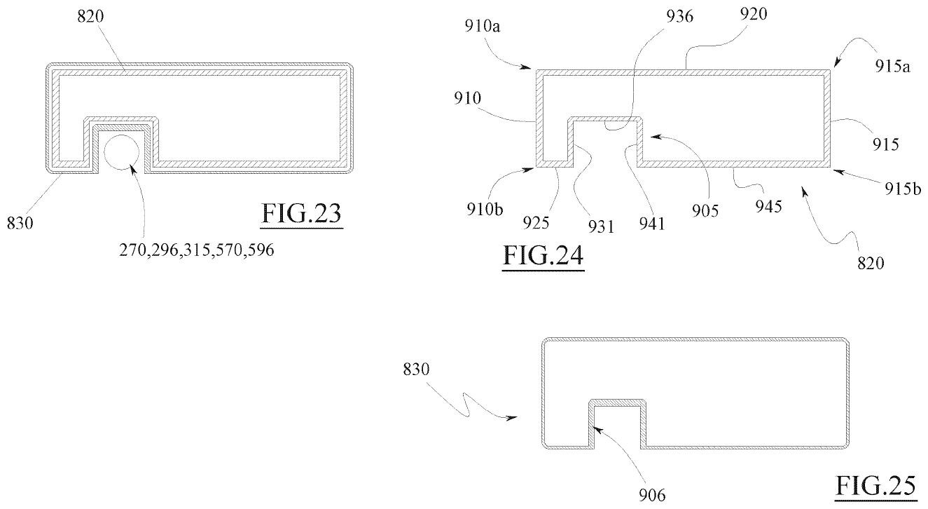

With particular reference to FIGS. 20-25, said male section 820,260,290,300a, 320a, 330a, 560,590,620a and female section 830,265,295,300b,320b, 330b,595,620b are slidingly associated in such a way as to be selectively moved in mutual approach/distancing along the respective direction of development (A,B) of the column or crosspiece.

Said male section 820,260,290,300a,320a,330a,560,590,620a comprises a protrusion 900, i.e., an externally protruding appendage, or an indentation 905.

Said protrusions 900 or indentations 905 extend longitudinally along the respective direction of development (A, B) of the columns and/or of the crosspieces.

More precisely, said protrusion 900 extends longitudinally along an entire sliding stroke between the male section 820,260,290,300a,320a, 330a,560,590,620a and the female section 830,265,295,300b, 320b, 330b, 595,620b of the columns and/or of the crosspieces. Possibly, said protrusion 900 or indentation 905 of the male section 820,260,290,300a, 320a, 330a, 560,590,620a extends along the entire extension of the column or crosspiece along the respective direction of development (A,B).

Said protrusion 900 or indentation 905 then extends in a direction perpendicular to the direction of development (A,B). More precisely, the protrusion 900 or indentation 905 extends along said direction by a non-zero amount.

Going into more detail, the male section 820,260,290,300a,320a,330a,560,590,620a comprises, along an entire portion thereof coupled to the female section 830,265,295,300b,320b,330b,595,620b, a cross-section, according to a section plane perpendicular to the direction of development of the columns and/or the crosspieces, provided with a base portion and a secondary portion.

Said base portion has a convex polygonal shape, e.g. it has a parallelogram shape.

In case the male section 260,290,300a,320a,330a,560,590,620a has a protrusion 900 rather than an indentation 905, said secondary portion protrudes externally with respect to said base portion.

For example, said secondary portion protrudes with respect to the base portion by a non-zero amount.

If, on the other hand, the male section 820 comprises an indentation 905, said secondary portion is presented as a cavity facing internally to the base portion.

Said female section 830,265,295,300b,320b,330b,595,620b comprises a portion conjugated 901,906 to said protrusion 900 or indentation 905 of the male section 820,260,290,300a,320a, 330a,560,590,620a, so as to form a prismatic connection therewith defining a sliding axis, parallel to the respective direction of development (A,B) of the column or crosspiece.

If the male section 260,290,300a,320a,330a,560,590,620a comprises a protrusion 900, the conjugated portion 901 of the female section 265,295,300b,320b,330b,595,620b also has a protrusion, external to that of the male section.

If, on the other hand, the male section 820 comprises an indentation 905, the conjugated portion 906 of the female section 830 also has an indentation fitted to measure in the indentation 905.

Said conjugated portion 901,906 extends longitudinally along said sliding axis for an entire sliding stroke between the male section 820,260,290,300a, 320a, 330a, 560,590,620a and the female section 830,265,295,300b,320b,330b, 595,620b.

Possibly, said conjugated portion 901,906 extends along the entire extension of said female section 830,265,295,300b,320b, 330b, 595,620b of the column or crosspiece along the respective direction of development (A,B).

The female section 830,265,295,300b,320b,330b,595,620b may also comprise a pair of stiffening flanges 908, located at opposite sides of the conjugated portion 901,906 and associated therewith transversely to the direction of development (A,B) of the crosspiece.

The female section 830,265,295,300b,320b,330b,595,620b comprises, along said portion 901,906 conjugated to the male section 820,260,290,300a, 320a, 330a, 560,590,620a, a cross-section (according to the aforesaid section plane perpendicular to the respective direction of development (A,B) of the columns and/or the crosspieces) provided with an inner perimeter that surrounds to measure an outer perimeter of the (aforementioned) cross-section of the male section 820,260,290,300a,320a, 330a, 560,590,620a.

If the male section 260,290,300a,320a,330a,560,590,620a comprises a protrusion 900, said outer perimeter comprises a first section 910 and an opposite second section 915.

Said first section 910 and second section 915 of the male section 260,290,300a,320a,330a, 560,590,620a are straight and parallel to each other.

They are also equal in length and are each one provided with a respective first longitudinal end 910a, 915a and a second longitudinal end 910b,915b.

The outer perimeter of the male section 260,290,300a,320a,330a,560,590,620a then comprises a third section 920.

Said third section 920 connects the first longitudinal ends 910a, 915a of the first section 910 and of the second section 915.

Said third section 920 is straight and is therefore perpendicular to said first section 910 and second section 915.

The outer perimeter of the male section 820,260,290,300a,320a,330a,560,590,620a then comprises a fourth section 925.

Said fourth section 925 is straight and develops from the second longitudinal end 910b of the first section 910, perpendicular thereto (and parallel to the third section 920) and in the direction of approach to the second section 915.

The outer perimeter of the male section 820,260,290,300a, 320a,330a, 560,590,620a then comprises a fifth section 930.

Said fifth section 930 is straight and develops from a longitudinal end of the fourth section 925 opposite the first section 910, perpendicular to the fourth section 925 (and parallel to the first section 910 and to the second section 915) in a direction of distancing from the third section 920.

The outer perimeter of the male section 820,260,290,300a,320a,330a, 560,590,620a then comprises a sixth section 935.

This sixth section 935 is straight and develops from a longitudinal end of the fifth section 930 opposite the fourth section 925.

It also develops perpendicular to said fifth section 930 (and parallel to the third section 920 and to the fourth section 935) and in the direction of approach to the second section 915.

In the present case, the sixth section 935 is located outside the base portion of the male section 260,290,300a,320a, 330a,560,590,620a.

The outer perimeter of the male section 820,260,290,300a, 320a, 330a, 560,590,620a then comprises a seventh section 940

The seventh section 940 develops from a longitudinal end of the sixth section 935 opposite the fifth section 930.

It also develops perpendicular to said sixth section 935 (and thus parallel to the first section 910, to the second section 915 and to the fifth section 930) and in a direction of approach to the third section 920 until it intersects an imaginary line connecting the second longitudinal end 910b of the first section 910 with the second longitudinal end 915b of the second section 915.

The outer perimeter of the male section 820,260,290,300a,320a,330a, 560,590,620a then comprises an eighth section 945.

Said eighth section 945 is straight and develops from a longitudinal end of the seventh section 940 opposite to the sixth section 935.

It also develops perpendicularly to said seventh section 940 (and thus parallel to the third section 920, to the fourth section 925 and to the sixth section 935) and connects (said longitudinal end of) the seventh section 940 to the second longitudinal end 915b of the second section 915.

The fifth section, sixth section and seventh section form said protrusion 900 of the male section.

If, on the other hand, the male section 820 comprises an indentation 905, said outer perimeter comprises a first section 910 and an opposite second section 915.

Said first section 910 and second section 915 of the male section 260,290,300a, 320a,330a, 560,590,620a are straight and parallel to each other. They are also equal in length and are each one provided with a respective first longitudinal end 910a, 915a and a second longitudinal end 910b, 915b.

The outer perimeter of the male section 260,290,300a,320a,330a,560,590,620a then comprises a third section 920.

Said third section 920 connects the first longitudinal ends 910a, 915a of the first section 910 and of the second section 915.

Said third section 920 is straight and is therefore perpendicular to said first section 910 and second section 915.

The outer perimeter of the male section 820,260,290,300a,320a,330a,560,590,620a then comprises a fourth section 925.

Said fourth section 925 is straight and develops from the second longitudinal end 910b of the first section 910, perpendicular thereto (and parallel to the third section 920) and in the direction of approach to the second section 915.

The outer perimeter of the male section 820,260,290,300a, 320a,330a, 560,590,620a then comprises a fifth section 931.

Said fifth section 931 is straight and develops from a longitudinal end of the fourth section 925 opposite the first section 910, perpendicularly to the fourth section 925 (and parallel to the first section 910 and to the second section 915) in a direction of approach to the third section 920.

The outer perimeter of the male section 820,260,290,300a,320a,330a,560,590,620a then comprises a sixth section 936.

This sixth section 936 is straight and develops from a longitudinal end of the fifth section 931 opposite the fourth section 925.

It also develops perpendicular to said fifth section 931 (and parallel to the third section 920 and to the fourth section 925) and in the direction of approach to the second section 915.

In the present case, the sixth section 936 is located internally with respect to the base portion of the male section 820.

The outer perimeter of the male section 820,260,290,300a,320a,330a, 560,590,620a then comprises a seventh section 941.

Said seventh section 941 develops from a longitudinal end of the sixth section 935 opposite the fifth section 931.

It also develops perpendicularly to said sixth section 936 (and thus parallel to the first section 910, to the second section 915 and to the fifth section 931) and in a direction of distancing from the third section 920 until it intersects said imaginary line.

The outer perimeter of the male section 820,260,290,300a,320a, 330a, 560,590,620a then comprises an eighth section 945.

Said eighth section 945 is straight and develops from a longitudinal end of the seventh section 941 opposite the sixth section 936.

It also develops perpendicularly to said seventh section 940,941 (and thus parallel to the third section 920, to the fourth section 925 and to the sixth section 936) and connects (said longitudinal end of) the seventh section 941 to the second longitudinal end 915b of the second section 915.

The fifth section, sixth section and seventh section form said indentation 905 of the male section.

The apparatus 201,501,501′,501″ according to the invention further comprises a linear actuator 270,296,315,570,596, configured to move the male section 820,260,290,300a, 320a, 330a, 560,590,620a and the female section 830,265,295,300b, 320b, 330b, 595,620b of the (at least one) column and/or crosspiece of the apparatus in mutual approach/distancing along the respective direction of development (A,B).

Said linear actuator 270,296,315,570,596, i.e., extends longitudinally along said respective direction of development (A,B).

For this purpose, the linear actuator 270,296,315,570,596 is provided with a cylinder, which makes available a first axial end of the actuator, associated with the male section 820,260,290,300a,320a,330a, 560,590,620a.

It is then provided with a piston, slidingly associated inside the cylinder and to which a rod is slidingly integral with respect to the cylinder, provided with a free end which protrudes externally from the cylinder and which makes available a second axial end of the actuator associated with the female section 830,265,295,300b,320b,330b,595,620b of the telescopic column or crosspiece of the apparatus.

Said linear actuator 270,296,315,570,596 of the apparatus is at least partially accommodated in the protrusion 900 or indentation 905 of the male section 820,260,290,300a,320a, 330a, 560,590,620a.

More precisely, the protrusion 900 or indentation 905 of the male section 820,260,290,300a,320a,330a,560,590,620a extends along the aforesaid direction transverse to the direction of development (A,B) of the columns or crosspieces by a sufficient amount such that said linear actuator 270,296,315,570,596 can be at least partially accommodated in said protrusion 900 or indentation 905 of the male section 820,260,290,300a,320a,330a, 560,590,620a.

More precisely, the protrusion male section 900 of the 260,290,300a,320a,330a, 560,590,620a extends along said direction, in such a way that a cross-section of the linear actuator 270,296,315,570,596, according to a section plane perpendicular to the aforesaid respective direction of development (A,B), is at least partially internally accommodated in a portion of the cross-section of the male section 260,290,300a,320a,330a,560,590,620a comprised between the aforesaid fifth section 930, sixth section 935, seventh section 940 and an imaginary line connecting the longitudinal end of the fourth section 925 from which the fifth section 930 develops with the longitudinal end of the seventh section 940 from which the eighth section 945 develops.

Furthermore, the indentation 905 of the male section 820 extends along said direction, in such a way that the aforesaid cross-section of the linear actuator 270,296,315,570,596, according to a section plane perpendicular to the aforesaid respective direction of development (A,B), is at least partially internally accommodated in a portion of the cross-section of the male section 820 comprised between the aforesaid fifth section 931, sixth section 936, seventh section 941 and an imaginary line connecting the longitudinal end of the fourth section 925 from which the fifth section 931 develops with the longitudinal end of the seventh section 941 from which the eighth section 945 develops.

Preferably, said linear actuator 270,296,315,570,596 is completely accommodated in the protrusion 900 or indentation 905 of the male section 820,260,290,300a, 320a, 330a, 560,590,620a.

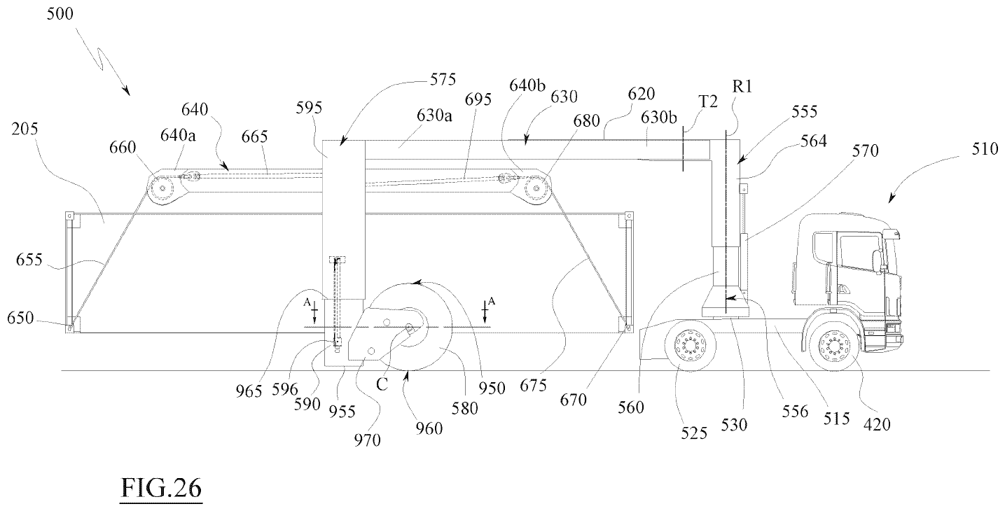

In this case, therefore, the aforesaid actuator cross-section 270,296,315,570,596 with respect to said section plane is completely internally accommodated in the above-described of the cross-section of the male section portion 820,260,290,300a,320a, 330a,560,590,620a comprised between the fifth section 930,931, the sixth section 935,936, the seventh section 940,941 and said imaginary line. In addition to the inside of the columns, like in the embodiments illustrated up to FIG. 25, there is also an alternative architecture for positioning the idle wheels, which architecture is applicable to all the embodiments illustrated in FIGS. 1-25. With particular reference to FIGS. 26-29, this different architecture provides that the first idle wheel 580 and the second idle wheel 605 are rotatably associated with the male section 560,590, respectively, of the second column 575 and of the third column 600 that are telescopic. Preferably, moreover, they are associated with said male section 560,590 in such a way that each of them is completely in an external position and adjacent (from a plan viewpoint) to the respective columns.

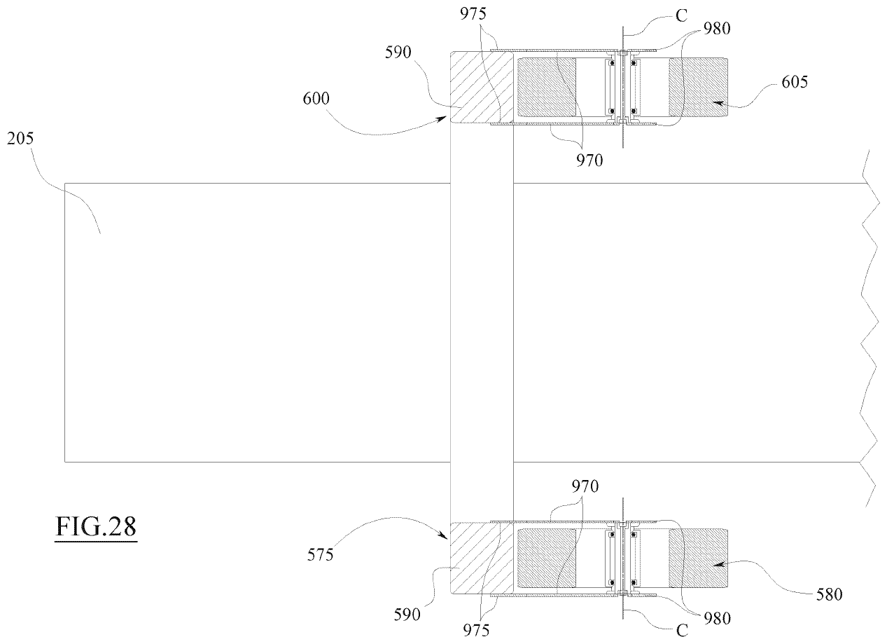

More precisely, as can be seen in FIG. 28, each idle wheel 580,605 is associated with the respective column in such a way that it is placed side by side in plan therewith. More precisely, each wheel 580,605 is placed side-by-side to the respective column without protruding externally, i.e. laterally, with respect to the (side) footprint of the same (and of the apparatus).

Preferably, then, each idle wheel 580,605 is associated with the male section 560,590 of the respective column in such a way that a top portion 950 of the wheel 580,605 itself is located at a vertical height equal to or (more preferably) higher than a vertical height of a lower end 955 of the male section 560,590.

Preferably, moreover, the lower end 955 of the male section 560,590 of each column is located at a height (strictly) higher than a lower portion 960 of the wheel 580,605, said lower portion 960 of the wheel 580,605 being adapted to come into contact with the ground.

Thus, the lower end 955 of the male section 560,590 of the column is preferably located at a vertical height comprised between a vertical height of the top portion 950 of the wheel 580,605 and a vertical height of the lower portion 960 of the wheel 580,605 (i.e., the ground).

Going into more detail, each idle wheel 580,605 is rotatably associated with the male section 560,590 of the respective column with respect to a horizontal axis of rotation C. According to a preferred and advantageous aspect, said axis of rotation C of the wheel 580,605 is located at a lower end portion of the aforesaid male section 560,590.

Preferably, therefore, each idle wheel 580,605 is adapted to be associated with the male section 560,590 of the respective column according to the characteristics stated above and in such a way that the axis of rotation C of the wheel 580,605 itself is located at the aforesaid lower end portion of the male section 560,590.

Even more preferably, the wheel 580,605 is adapted to be associated with the male section 560,590 of the respective column in such a way that the axis of rotation thereof C is located at a vertical height equal to or greater than a vertical height of the lower end 955 of the male section 560,590.

In this way, the lower end 955 of the male section 560,590 of the column is preferably located at a vertical height comprised between a vertical height of the axis of rotation C of the wheel 580,605 and a vertical height of the lower portion 960 of the wheel 580,605 (i.e. the ground).

The apparatus 501,501′,501″ is therefore configured to come into contact with the ground solely and exclusively through the (lower portion 960 of the) wheel 580,605.

More specifically, said axis of rotation C is, for example, in turn completely external to the column, i.e. never intersects it.

That is, for example, each axis of rotation C is perpendicular to a lying plane of the directions of vertical development A, B of the columns.

Further, the female section 595 of each of the columns is preferably movable between a first position (visible in FIG. 26), in which a lower end 965 thereof is located at a vertical height greater than the vertical height of the top portion 950 of the wheel, and a second position, in which said lower end 965 of the female section 595 is located at a vertical height substantially equal to or lower than the aforesaid vertical height of the top portion 950 of the wheel 580,605.

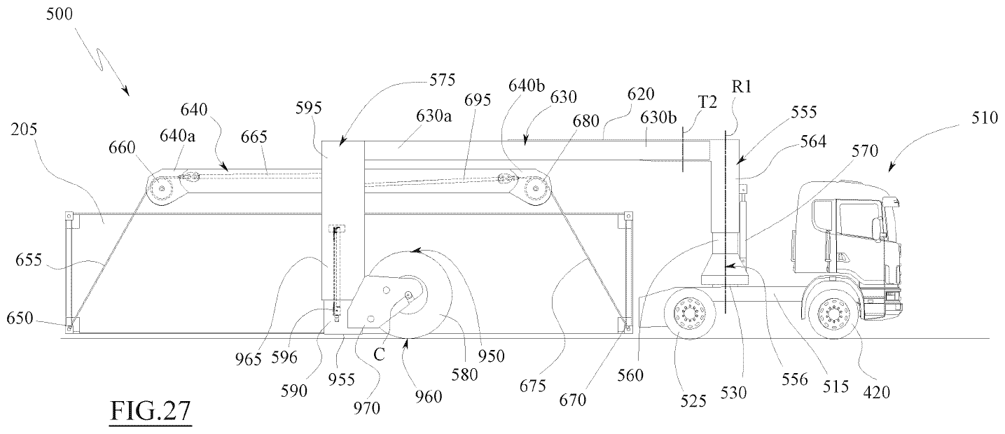

Preferably, as visible in FIG. 27, in said second position the lower end 965 of the female section 595 is located at a vertical height comprised between the aforesaid vertical height of the top portion 950 of the wheel 580,605 and the vertical height of the axis of rotation C of the wheel 580,605.

Even more preferably, in the second position the lower end 965 is located at a vertical height comprised between the aforesaid vertical height of the axis of rotation C of the wheel 580,605 and the vertical height of a lower portion 960 of the wheel 580,605 (i.e. the ground).

Each wheel 580,605 is advantageously associated with the respective column by means of at least one connection element 970, for example by means of a flange.

Each wheel 580,605 is preferably associated with the respective column by means of a pair of connection elements 970, for example two flanges, which are connected to the respective wheel 580,605 at axially opposite ends thereof.

Each connection element 970 is preferably provided with a first end portion 975, adapted to be fixed without residual degrees of freedom to the male section 560,590 of the respective column.

It is then preferably provided with a second end portion 980, adapted to be rotatably associated with the wheel 580,605 at the axis of rotation thereof C.

It is also possible, in some particularly advantageous embodiments of the invention, that each outer idle wheel 580,605 comprises a pair of twin idle wheels.

As an alternative to the embodiments described above, wherein the actuation arrangement comprises a respective rope 355,375,655,675 is partially wrapped around a respective idle wheel 360,380,660,680 (hinged to one end of the arm distal from the column) and moved by a respective actuator 365,385,665,695 (e.g. linear), a different embodiment of the actuation arrangement of the gripping body can be provided in which there is no idle wheel but only an actuator 985, a rope (or chain) and a gripping body. This embodiment of the actuation arrangement is applicable to all described embodiments of the lifting apparatus, i.e. the lifting arrangement.

The actuation arrangement may comprise a single arm 640,645 as illustrated in the embodiments of FIGS. 10-27 or a pair of arms 340,345 for each column and hinged to the respective column as illustrated in FIGS. 1-9 and 29.

In particular, the actuation arrangement comprises four actuators each adapted to move a respective gripping body. In addition, each actuator is associated with a respective arm 340,345 of the actuation arrangement.

Each of said actuators 985, for example of the linear type, is preferably adapted to be hinged with respect to at least one axis of rotation D (horizontal) at one end of the respective arm distal from the respective column.

More precisely, said actuator is adapted to be hinged to the end of the arm opposite to the end by which said arm is hinged to the respective column.

Preferably, the actuator 985 may comprise a first portion 990, which is adapted to be hinged (with respect to at least said axis of rotation), at the first longitudinal end thereof, to (the distal end from the column of) the respective arm. Alternatively, the first portion could be connected by a ball joint. Preferably the fact of being hinged or the ball joint are the only degrees of freedom with which the entire actuator is connected to the respective arm.

The actuator 985 may further comprise a second portion 995 which is movable and slidingly associated with the first portion 990 (with respect to a straight sliding axis).

Said second portion 995 is for example and preferably associated with the first portion 990 such that it slides at least partially within it.

Preferably, it is also associated with the first portion 990 in such a way that it at least partially comes out from a second longitudinal end thereof, which is opposite the first end (hinged to the arm).

The actuator is therefore, for example, a double-acting hydraulic cylinder with a rod passing through only one axial end of the cylinder.

Said first portion 990 of the actuator 985 may be (and preferably is) for example a cylinder of the hydraulic cylinder and said second portion 995 may be (and preferably is) for example a rod of the hydraulic cylinder.

Such a rod is therefore preferably adapted to be slidingly associated with the first portion 990, i.e. preferably with the hydraulic cylinder, of the actuator 985 so as to slide at least partially within it.

The second portion 995 is also preferably associated, at a free longitudinal end thereof, distal from the first end of the first portion 990, with an inextensible rope.

This rope is also associated, for example hinged, with the gripping body, such as a hook. It is possible that, in alternative and advantageous embodiments of the invention, the second portion of the actuator 985 is associated with a ring chain, rather than with an inextensible rope.

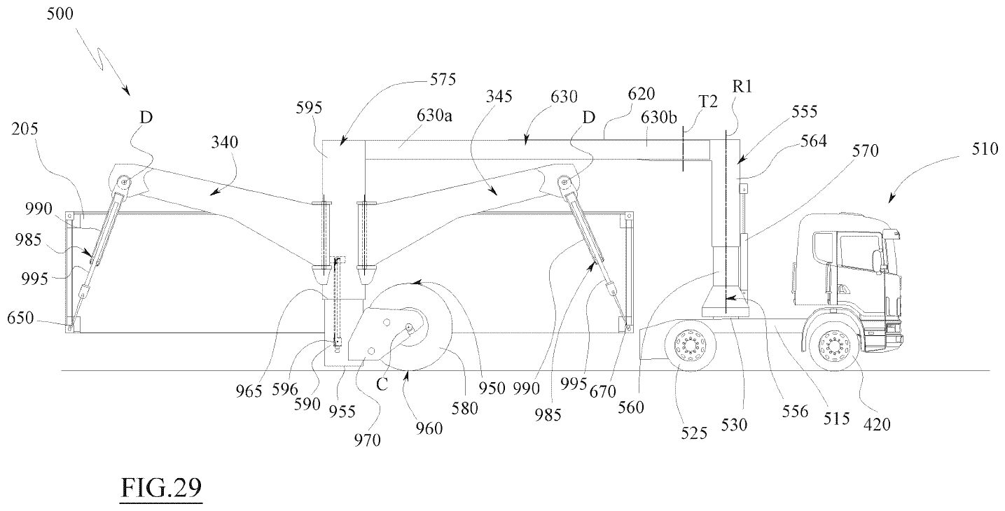

The length in the longitudinal direction of the actuator is greater than the length of the rope or chain when it is extended, in particular it is greater than at least 2 times the length of the rope or chain when it is extended. In this way the flexible element, i.e. the rope or chain, has a small length, thus reducing the oscillations of the container during transport. This actuation arrangement illustrated in FIG. 29 allows, by moving the second portion of each actuator towards the arm to which the actuator is hinged, to carry out a first portion of the lifting or lowering of the container to be lifted. Then the rest of the operation (lifting or lowering) is carried out by the telescopic columns.

The actuator 985 is therefore designed to vary the position of the inextensible rope and of the gripping body depending on the size of the container 205 to be lifted. This variation of the aforesaid position occurs by means of the movement of the second portion 995 of the actuator 985 in approach/distancing from the first portion thereof 990.

It should be noted that the actuator 985 is designed solely and exclusively to move (the second portion 995 in approach/distancing from the first portion 990 so as to move) the rope (or the chain) and the respective gripping body depending on the size of the container 205, and that it does not play any role in lifting the container 205 itself from the surface on which it rests (which role is entirely entrusted to the movement of the female section of the respective column with respect to the male section thereof along the direction of development of the column itself).

The invention thus conceived is susceptible to several modifications and variations, all falling within the scope of the inventive concept.

Moreover, all details can be replaced by other technically equivalent elements.

In practice, the materials used, as well as the contingent shapes and sizes, can be what ever according to the requirements without for this reason departing from the scope of protection of the following claims.

1. A variable footprint handling apparatus for handling containers comprising:
a first column adapted to be associated with the fifth wheel of a tractor,
a second column to which a first idle ground support wheel is idly associated,
a third column to which a second idle ground support wheel is idly associated,
a lifting arrangement for lifting the container,
a connection arrangement that connects the second column and the third column to the first column and is configured to move at least one of the three columns with respect to another of the three columns between a first position, and a second position, wherein a footprint in plan of the apparatus in said second position is smaller than a footprint in plan of the apparatus in said first position.
wherein the third column and the second column are of the telescopic type, and wherein the first idle wheel and the second idle wheel of the apparatus are rotatably associated with a male section, respectively, of the second column and of the third column that are telescopic and are completely in an external position and adjacent to the respective column.

2. The apparatus according to claim 1, wherein a female section of each column is movable between a first position, in which a lower end thereof is located at a vertical height greater than a vertical height of the top portion of the wheel, and a second position, in which the lower end of the female section is located at a vertical height lower than the vertical height of the top portion of the wheel.

3. The apparatus according to claim 1, wherein each wheel is associated with the male section of the respective column in such a way that a top portion of the wheel is located at a vertical height equal to or greater than a vertical height of a lower end of the male section.

4. The apparatus according to claim 2, wherein each wheel is rotatably associated with the male section of the respective column with respect to a horizontal axis of rotation at a lower end portion of said male section.

5. The apparatus according to claim 2, wherein each wheel is associated with the male section of the respective column in such a way that the axis of rotation is located at a vertical height equal to or greater than a vertical height of a lower end of the male section.

6. The apparatus according to claim 1, wherein the connection arrangement is configured to move at least one between the second column and the third column between a first position, in which the distance of the third column from the second column is maximum, and a second position in which said distance is minimum.

7. The apparatus according to claim 6, wherein the connection arrangement comprises:
a first crosspiece provided with a first end connected to the first column and a second end connected to the third column,
a second crosspiece provided with a first end rigidly fixed to the second column and a second end hinged to one between the first column and the first crosspiece with respect to a vertical axis of rotation,
an actuator configured to move the second column in rotation with respect to said vertical axis of rotation.
